(19) United States
(12) Patent Application Publication
(10) Pub. No.: US 2025/0049266 A1
(43) Pub. Date: Feb. 13, 2025

(54) ADAPTABLE PORTABLE DOUCHE APPARATUS

(71) Applicant: Mr Bear Enterprise, LLC, Falls Church, VA (US)

(72) Inventor: Glen P. Almond, Falls Church, VA (US)

(21) Appl. No.: 18/401,546

(22) Filed: Dec. 31, 2023

Related U.S. Application Data
(63) Continuation-in-part of application No. 18/231,687, filed on Aug. 8, 2023.

(51) Int. Cl. A47K 3/28; B05B 11/00

(52) U.S. Cl. CPC A47K 3/28; B05B 11/0008

(57) ABSTRACT

A douche apparatus adaptable to a bottle and configurable for storage and portability may comprise a nozzle and an adapter assembly having one or more bottle adapters, a nozzle attachment end, a bottle attachment end and an adapter assembly central portion. The douche apparatus is configurable for storage and portability, wherein the nozzle may be detached from the adapter assembly and be situated within the adapter assembly central portion. The douche apparatus may further comprise a case having a case housing and a case cap having an interior side comprising threads mateable to the bottle attachment end, wherein the adapter assembly may be attached to the interior side of the case cap prior to an attachment of the case cap to the case housing. The douche apparatus may further comprise a check valve removably attachable to the adapter assembly using the case cap as an assembly and disassembly tool.

### CROSS-REFERENCE TO RELATED APPLICATIONS

This application is a continuation-in-part of, and claims the benefit of, copending U.S. patent application Ser. No. 18/231,687, filed Aug. 8, 2023, which is hereby incorporated by reference in its entirety herein.

### BACKGROUND

The present disclosure relates to douche apparatuses and more particularly relates to an adaptable portable douche apparatus.

### SUMMARY

Various implementations of a douche apparatus of the present invention are disclosed. In some aspects, the techniques described herein relate to a douche apparatus adaptable to a bottle and configurable for storage and portability, including: a nozzle having a nozzle channel through which a liquid may flow during use, a proximate end having a nozzle attachment feature, a distal end having a nozzle tip and a nozzle body extending from the nozzle attachment feature up to and including the nozzle tip including a nozzle wall circumscribing the nozzle channel, wherein the nozzle has at least one orifice disposed on the nozzle tip or the nozzle wall through which a liquid may be dispensed during use; and an adapter assembly having one or more adapters, a nozzle attachment end mateable to the nozzle attachment feature removably attaching the nozzle to the adapter assembly, a bottle attachment end including bottle attachment threads, and an adapter assembly central portion through which a liquid may flow during use, wherein: the douche apparatus is configurable for storage and portability, wherein the nozzle may be detached from the adapter assembly and the nozzle body may be situated at least partially within the adapter assembly central portion; and the douche apparatus is adaptable to a squeezable bottle for use, wherein the squeezable bottle includes a volume of liquid and has bottle threads, wherein the bottle attachment threads are mateable to the bottle threads.

In some aspects, the techniques described herein relate to a douche apparatus, wherein the adapter assembly has a single adapter, and the single adapter includes the nozzle attachment end and the bottle attachment end.

In some aspects, the techniques described herein relate to a douche apparatus, wherein the bottle attachment end is a second bottle attachment end, and the adapter assembly includes: a first adapter including the nozzle attachment end and a first bottle attachment end; and a second adapter including the second bottle attachment end and an adapter attachment end mateable and removably attached to the first bottle attachment end, wherein: the bottle attachment threads are second bottle attachment threads; the first bottle attachment end includes first bottle attachment threads matcable with threads of a bottle including bottle threads of a first type; the second bottle attachment end includes the second bottle attachment threads matcable with threads of a bottle including bottle threads of a second type; the douche apparatus is adaptable to a squeezable bottle for use, wherein the squeezable bottle includes a volume of liquid and has bottle threads of the second type; and the douche apparatus is adaptable to a squeezable bottle for use, wherein the squeezable bottle includes a volume of liquid and has bottle threads of the first type, and the second adapter is detached from the adapter assembly thereby exposing the first bottle attachment end including the first bottle attachment threads.

In some aspects, the techniques described herein relate to a douche apparatus, wherein the bottle attachment end is a third bottle attachment end, and the adapter assembly includes: a first adapter including the nozzle attachment end and a first bottle attachment end; a second adapter including a second bottle attachment end and a first adapter attachment end matcable and removably attached to the first bottle attachment end; and a third adapter including the third bottle attachment end and a second adapter attachment end matcable and removably attached to the second bottle attachment end, wherein: the bottle attachment threads are third bottle attachment threads; the first bottle attachment end includes first bottle attachment threads mateable with threads of a bottle including bottle threads of a first type; the second bottle attachment end includes second bottle attachment threads mateable with threads of a bottle including bottle threads of a second type; the third bottle attachment end includes the third bottle attachment threads matcable with threads of a bottle including bottle threads of a third type; the douche apparatus is adaptable to a squeezable bottle for use, wherein the squeezable bottle includes a volume of liquid and has bottle threads of a third type; the douche apparatus is adaptable to a squeezable bottle for use, wherein the squeezable bottle includes a volume of liquid and has bottle threads of a second type, and the third adapter is detached from the adapter assembly thereby exposing the second bottle attachment end including the second bottle attachment threads; and the douche apparatus is adaptable to a squeezable bottle for use, wherein the squeezable bottle includes a volume of liquid and has bottle threads of the first type, and the second adapter and third adapter are detached from the adapter assembly thereby exposing the first bottle attachment end including the first bottle attachment threads.

In some aspects, the techniques described herein relate to a douche apparatus, further including a check valve, wherein the check valve is configured be removably attached to the adapter assembly to allow liquid to flow through the adapter assembly and the nozzle channel and dispense through the at least one orifice and to prevent liquid from flowing in a reverse direction thereof.

In some aspects, the techniques described herein relate to a douche apparatus, wherein when configured for storage and portability, the nozzle body may be situated wholly within the adapter assembly central portion.

In some aspects, the techniques described herein relate to a douche apparatus, wherein when configured for storage and portability, the nozzle tip is directed towards the bottle attachment end and the nozzle attachment feature is removably attached to the nozzle attachment end.

In some aspects, the techniques described herein relate to a douche apparatus, further including a case having a case housing and a case cap, wherein: the case cap is removably attachable to the case housing; the case cap has an exterior side and an interior side, wherein, when attached to the case housing, the interior side is directed towards an interior of the case housing; and the case cap includes threads mateable to the bottle attachment end, wherein the adapter assembly is configured to be removably attached to the interior side of the case cap prior to an attachment of the case cap to the case housing, thereby storing the adapter assembly within the case.

In some aspects, the techniques described herein relate to a douche apparatus, wherein the case cap further includes threads mateable to the nozzle attachment feature, wherein the nozzle is configured to be removably attached to the interior side of the case cap and be situated at least in part within the adapter assembly central portion.

In some aspects, the techniques described herein relate to a douche apparatus, wherein the exterior side of the case cap includes a recess area proximate to a graspable member of the case cap.

In some aspects, the techniques described herein relate to a douche apparatus, further including a check valve, wherein: the check valve is configured to be removably attached to the adapter assembly at the bottle attachment end, allow liquid to flow through the adapter assembly and the nozzle channel and dispense through the at least one orifice, and prevent liquid from flowing in a reverse direction thereof; and the case cap is configured to facilitate attachment of the check valve to the adapter assembly, wherein: a check valve attachment feature of the check valve is configured to be removably attached to threads of the adapter assembly by a rotation of the check valve relative to the adapter assembly; and the interior side of the case cap is configured to receive an end of the check valve opposite from the check valve attachment feature and prevent a rotation of the check valve relative to the case cap, wherein a grasping and rotating of the graspable member thereby rotates the check valve facilitating attachment of the check valve to the adapter assembly using the case cap as an assembly tool.

In some aspects, the techniques described herein relate to a douche apparatus, further including a stimulation device removably attachable to the nozzle attachment end of the adapter assembly.

In some aspects, the techniques described herein relate to a douche apparatus, wherein the stimulation device includes a vibrator mechanism and a power source for the vibrator mechanism.

In some aspects, the techniques described herein relate to a douche apparatus, wherein each of the one or more adapters include a plurality of nubs configured to facilitate a grip thereon.

In some aspects, the techniques described herein relate to a douche apparatus adaptable to a bottle and configurable for storage and portability, including: a nozzle having a nozzle channel through which a liquid may flow during use, a proximate end having a nozzle attachment feature, a distal end having a nozzle tip and a nozzle body extending from the nozzle attachment feature up to and including the nozzle tip including a nozzle wall circumscribing the nozzle channel, wherein the nozzle has at least one orifice disposed on the nozzle tip or the nozzle wall through which a liquid may be dispensed during use; one or more adapters, each including a nozzle attachment end mateable to the nozzle attachment feature removably attaching the nozzle to one of the one or more adapters, a bottle attachment end including bottle attachment threads, and an adapter central portion through which a liquid may flow during use; and a case having a case housing and a case cap, wherein: the case cap is removably attachable to the case housing; the case cap has an exterior side and an interior side, wherein, when attached to the case housing, the interior side is directed towards an interior of the case housing; the case cap includes threads mateable to the nozzle attachment feature, wherein each of the one or more adapters may be stacked on the case cap having the nozzle body situated at least in part within at least one adapter central portion; and the douche apparatus is adaptable to a squeezable bottle for use, wherein the squeezable bottle includes a volume of liquid and has bottle threads, wherein the bottle attachment threads of one of the one or more adapters are mateable to the bottle threads.

In some aspects, the techniques described herein relate to a douche apparatus, wherein the douche apparatus has a single adapter, and the single adapter includes bottle attachment threads of a first type.

In some aspects, the techniques described herein relate to a douche apparatus, wherein the douche apparatus includes a first adapter and a second adapter, wherein the first adapter includes bottle attachment threads of a first type and the second adapter includes bottle attachment threads of a second type.

In some aspects, the techniques described herein relate to a douche apparatus, wherein the douche apparatus includes a first adapter, a second adapter and a third adapter, wherein the first adapter includes bottle attachment threads of a first type, the second adapter includes bottle attachment threads of a second type and the third adapter includes bottle attachment threads of a third type.

In some aspects, the techniques described herein relate to a douche apparatus, wherein when configured for storage and portability, the nozzle body may be situated wholly within a combined adapter central portions of the first adapter, second adapter and third adapter.

In some aspects, the techniques described herein relate to a douche apparatus, wherein the exterior side of the case cap includes a recess area proximate to a graspable member of the case cap.

In some aspects, the techniques described herein relate to a douche apparatus, further including a check valve, wherein the check valve is configured to allow liquid to flow through the nozzle channel and dispense through the at least one orifice and prevent liquid from flowing in a reverse direction thereof.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of the disclosed subject matter.

FIG. 1A depicts a perspective view of an example implementation of a douche apparatus of the present invention.

FIG. 1B depicts an example implementation of a nozzle detached from the douche apparatus of FIG. 1A and shown in a side elevation view cross-section.

FIG. 1C a cross-section of the example implementation of the nozzle of FIG. 1B.

FIG. 1D depicts a perspective view of an example implementation of a douche apparatus of the present invention having a nozzle, wherein the nozzle comprises a plurality of orifices.

FIG. 1E depicts a perspective view of the douche apparatus of FIG. 1A (or FIG. 1D) configured in a storage-orientation.

FIG. 2A depicts a partially exploded perspective view of the douche apparatus of FIG. 1A adapted to a squeezable bottle having bottle threads of a third type.

FIG. 2B depicts a partially exploded perspective view of the douche apparatus of FIG. 1A adapted to a squeezable bottle having bottle threads of a second type.

FIG. 2C depicts a partially exploded perspective view of the douche apparatus of FIG. 1A adapted to a squeezable bottle having bottle threads of a first type.

FIG. 3A depicts a perspective view of an exploded assembly of the douche apparatus of FIG. 1A.

FIG. 3B depicts a side elevation view of an example first bottle adapter of the douche apparatus of FIG. 3A.

FIG. 3C depicts a cross-section of the bottle adapter of FIG. 3B.

FIG. 3D depicts a side elevation view of an example second bottle adapter of the douche apparatus of FIG. 3A.

FIG. 3E depicts a cross-section of the bottle adapter of FIG. 3D.

FIG. 3F depicts a side elevation view of an example third bottle adapter of the douche apparatus of FIG. 3A.

FIG. 3G depicts a cross-section of the bottle adapter of FIG. 3F.

FIG. 4A depicts a perspective view of the example douche apparatus of FIG. 1A (or FIG. 1D) in a storage-orientation situated between components of an example storage case.

FIG. 4B depicts a side elevation view of a case housing of FIG. 4A.

FIG. 4C a cross-section of the case housing of FIG. 4B.

FIG. 4D depicts a side elevation view of a case cap of FIG. 4A.

FIG. 4E depicts a cross-section of the case cap of FIG. 4D.

FIG. 5A depicts a perspective view of an example douche apparatus of the present invention in a storage-orientation situated between components of an example storage case.

FIG. 5B depicts a side elevation view of a case housing of FIG. 5A.

FIG. 5C a cross-section of the case housing of FIG. 5B.

FIG. 5D depicts a side elevation view of a case cap of FIG. 5A.

FIG. 5E depicts a cross-section of the case cap of FIG. 5D.

FIG. 5F depicts a perspective view of an example implementation of a nozzle.

FIG. 6A depicts a perspective view of an example douche apparatus of the present invention in a storage-orientation situated between components of an example storage case.

FIG. 6B depicts a side elevation view of a case housing of FIG. 6A.

FIG. 6C depicts a cross-section of the case housing of FIG. 6B.

FIG. 6D depicts a side elevation view of a case cap of FIG. 6A.

FIG. 6E depicts a cross-section of the case cap of FIG. 6D.

FIG. 6F depicts a perspective view of an example implementation of a nozzle.

FIG. 7A depicts a side elevation view of a first bottle adapter of the douche apparatus of FIG. 6A.

FIG. 7B depicts a cross-section of the bottle adapter of FIG. 7A.

FIG. 7C depicts a side elevation view of a second bottle adapter of the douche apparatus of FIG. 6A.

FIG. 7D depicts a cross-section of the bottle adapter of FIG. 7C.

FIG. 7E depicts a side elevation view of a third bottle adapter of the douche apparatus of FIG. 6A.

FIG. 7F depicts a cross-section of the bottle adapter of FIG. 7E.

FIG. 7G depicts a partial perspective view of a squeezable bottle having attached the douche apparatus of FIG. 6A.

FIG. 8A depicts a side elevation view of an example stimulation device.

FIG. 8B depicts a side elevation view of an example douche apparatus of the present invention further comprising a stimulation device.

FIG. 8C depicts a side elevation view of a nozzle attachable as a handle for the douche apparatus of FIG. 8B comprising a stimulation device.

FIG. 8D depicts a cross-section of the nozzle attachable as a handle of FIG. 8C.

FIG. 8F depicts a stimulation device having a vibrator mechanism.

FIG. 9A depicts a perspective view of an example partially exploded assembly of an example implementation of a douche apparatus of the present invention.

FIG. 9B depicts a side elevation view of an example first bottle adapter of the douche apparatus of FIG. 9A.

FIG. 9C depicts a cross-section of the bottle adapter of FIG. 9B.

FIG. 9D depicts a side elevation view of an example second bottle adapter of the douche apparatus of FIG. 9A.

FIG. 9E depicts the indicated cross-section of the bottle adapter of FIG. 9D.

FIG. 9F depicts a side elevation view of an example third bottle adapter of the douche apparatus of FIG. 9A.

FIG. 9G depicts the indicated cross-section of the bottle adapter of FIG. 9F.

FIG. 9H depicts an exploded perspective view of an example implementation of a check valve of the douche apparatus of FIG. 9A.

FIG. 9I depicts a partial side view of a squeezable bottle with portions of the douche apparatus of FIG. 1A attached thereto.

FIG. 9J shows the interoperation and mating among a bottle, a bottle adapter and a check valve.

FIG. 9K depicts a partially exploded perspective view of the douche apparatus of FIG. 9A assembled in a storage configuration situated between components of a storage case.

FIG. 9L depicts a perspective view of the douche apparatus of FIG. 9A in a storage configuration and assembled to a case cap.

### DETAILED DESCRIPTION

Detailed implementations of a douche apparatus of the present invention are disclosed herein. It will be apparent to those skilled in the art that while the disclosed implementations are instructive in how to practice the invention presently disclosed herein, they are not exhaustive and other implementations which are within the scope of the appended claims may be conceived when given the benefit of the present disclosure. As such, the implementations of the present disclosure may be considered instructive but not restrictive.

The following detailed implementations refer to the accompanying drawings. The same reference number may appear in multiple figures of the drawings and when appearing in multiple figures will identify the same or similar elements.

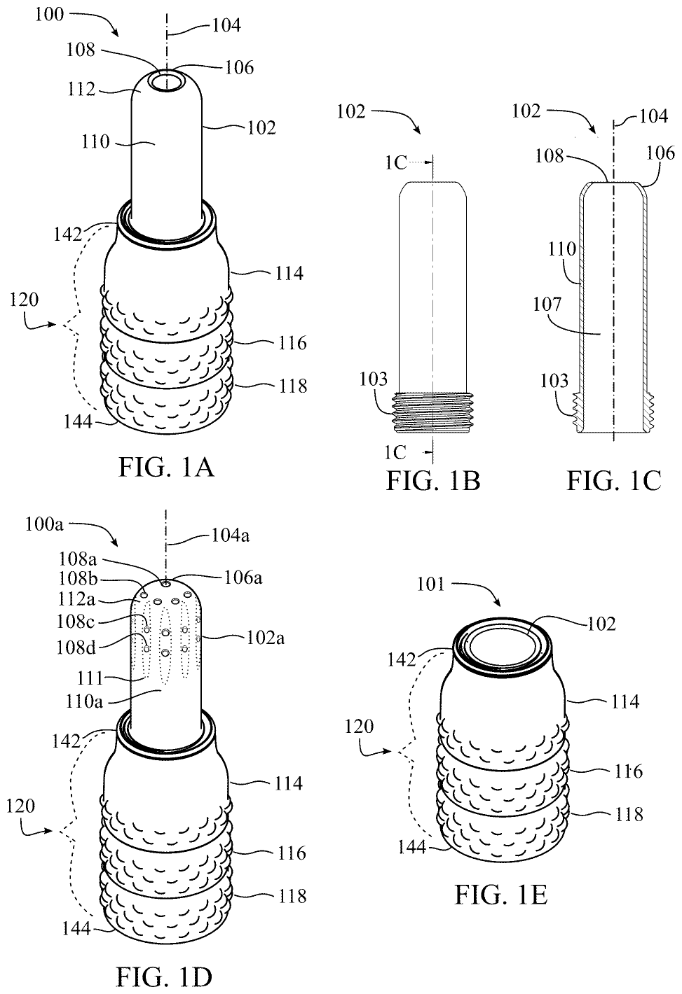

FIG. 1A depicts a perspective view of an example implementation of a douche apparatus 100 of the present invention. Douche apparatus 100 comprises a nozzle 102 configured to be insertable into a cavity to be douched and to dispense a douche liquid therein. Nozzle 102 may be elongate and terminate at its distal end in a rounded nozzle tip 106 wherein nozzle tip 106 has an orifice 108 through which a liquid may be dispensed. FIG. 1B and FIG. 1C depict an example implementation of nozzle 102 detached from douche apparatus 100 and shown in a side elevation view and a cross-section view thereof, respectively. At its proximate end, nozzle 102 may comprise a nozzle attachment feature 103, which in some implementations may be male threads as shown in FIG. 1B. As will be apparent to those skilled in the art, in some implementations a mating feature other than threads as depicted in FIG. 1B are possible and within the scope of the appended claims, such as a bayonet mount or other such suitable matcable feature. In some implementations, nozzle attachment feature 103 may comprise a ½ inch male NPS thread, where NPS refers to National Pipe Straight of the American National Standard Pipe Thread standards; in some implementations nozzle attachment feature 103 may comprise a ½ inch male BSP parallel thread, where BSP refers to British Standard Pipe standards, or may comprise another suitable thread. FIG. 1B shows section line 1C-1C, and FIG. 1C depicts the indicated cross-section view, wherein an axis 104 may be circumscribed by a nozzle wall 110 forming a nozzle channel 107 having an opening at nozzle attachment feature 103 into which liquid may flow and an orifice 108 from which liquid may flow and be dispensed. A nozzle body may be a portion of nozzle 102 extending from nozzle attachment feature 103 up to and including nozzle tip 106.

An elongate shape of nozzle 102 and rounded configuration of nozzle tip 106 may facilitate penetration into a cavity and reduce or eliminate discomfort associated with such penetration. A user of douche apparatus 100 may apply a lubricant to tip 106 to further facilitate penetration into a cavity. Nozzle 102 may comprise one or more orifices or openings though which liquid may flow and be dispensed, such as a single orifice such as orifice 108 as depicted in FIG. 1A which may be configured to dispense liquid at nozzle tip 106. Configured as shown in FIG. 1A, nozzle 102 can penetrate a cavity, such as a vaginal or anal cavity, and dispense a liquid though orifice 108 within the penetrated cavity thereby douching the penetrated cavity. In the example implementation of FIG. 1A, a douche liquid dispensed with a force sufficient to project the liquid from nozzle 102 through orifice 108 will tend to direct the liquid along axis 104 of nozzle 102, however many other nozzle and orifice configurations are possible. For example, in some implementations, one or a plurality of orifices may be disposed on wall 110 of nozzle 102 and/or a sloping wall 112 of nozzle tip 106 such that a jet or spray of dispensed liquid can issue from orifices disposed off-axis (not shown in FIG. 1A) and project off-angle from axis 104 of nozzle 102, thereby providing alternative spray patterns to that of a spray pattern primarily directed along axis 104. Users may prefer a spray pattern directed solely generally along axis 104 as may be produced by nozzle 102 of the example implementation of FIG. 1A, or they may prefer a nozzle configured to produce a spray pattern which alternatively or additionally provides an off-angle spray pattern from axis 104 of nozzle 102.

Douche apparatus 100 may comprise an adapter assembly 120 having one or more bottle adapters, wherein three are depicted in the example implementation of FIG. 1A, namely bottle adapter 114, to which nozzle 102 is attached, bottle adapter 116 and bottle adapter 118. Nozzle 102 may have a nozzle attachment feature at its proximate end (not visible in FIG. 1A) configured to mate with a nozzle attachment end 142 of adapter assembly 120 (comprised by bottle adapter 114 of adapter assembly 120) which is at the opposite end from a bottle attachment end 144 of adapter assembly 120. Each bottle adapter, i.e., bottle adapter 114, bottle adapter 116 and bottle adapter 118, may be configured to attach at least a portion of douche apparatus 100 comprising nozzle 102 to a flexible sided container (e.g., a squeezable bottle) comprising a volume of liquid, such as for example, a conventional plastic water bottle comprising water. When using water, such as that found in a conventional plastic water bottle, a user may choose to add salt to produce a saline solution or choose to add some other desired additive prior to douching.

FIG. 1D depicts a perspective view of an example implementation of a douche apparatus 100a of the present invention having a nozzle 102a, wherein nozzle 102a comprises a tip 106a, a wall 110a and a plurality of orifices, such as orifice 108a, orifice 108b and orifice 108c. In the example implementation of FIG. 1D, orifice 108a is located on tip 106a along axis 104a, orifice 108b is located on sloping wall 112a of tip 106a and orifice 108c is located on wall 110a of nozzle 102a, wherein a douche liquid dispensed with a force sufficient to project the liquid from nozzle 102a through orifices orifice 108a, orifice 108b and orifice 108c will tend to direct liquid through orifice 108a along axis 104a and direct liquid though orifice 108b and orifice 108c off-angle from axis 104a. A spray pattern produced by the orifice configuration depicted in FIG. 1D may facilitate cleansing and/or medicating of sidewalls of a cavity being douched through off-angle spray which may thereby direct liquid spray toward cavity sidewalls. In some implementations, only off-axis orifices, e.g., such as orifice 108b and orifice 108c may be configured, i.e. where orifice 108a is not configured. As will be apparent to those skilled in the art, many possible orifice configurations are possible.

An orifice located on a nozzle wall may be blocked by intimate contact between a cavity wall and nozzle wall 110a, wherein the cavity wall acts to block the orifice thereby impeding flow therethrough. In the example implementation of FIG. 1D, nozzle 102a comprises recessed portions in wall 110a, such as recessed portion 111. Recessed portion 111 may comprise orifices 108c and 108b, wherein orifice 108c and orifice 108d may remain unimpeded despite intimate contact between a cavity wall by virtue of their recess providing a gap between them and the cavity wall.

Douche apparatus 100a may comprise an adapter assembly 120 having one or more bottle adapters, wherein three are depicted in the example implementation of FIG. 1D, namely bottle adapter 114, to which nozzle 102a is attached, bottle adapter 116 and bottle adapter 118. Nozzle 102a may have a nozzle attachment feature at its proximate end (not visible in FIG. 1D) configured to mate with a nozzle attachment end 142 of adapter assembly 120 (comprised by bottle adapter 114 of adapter assembly 120) which is at the opposite end from a bottle attachment end 144 of adapter assembly 120. Each bottle adapter, i.e., bottle adapter 114, bottle adapter 116 and bottle adapter 118, may be configured to attach at least a portion of douche apparatus 100a comprising nozzle 102a to a flexible sided container (e.g., a squeezable bottle) comprising a volume of liquid, such as for example, a conventional plastic water bottle comprising water. When using water, such as that found in a conventional plastic water bottle, a user may choose to add salt to produce a saline solution or choose to add some other desired additive prior to douching.

FIG. 1E depicts a perspective view of the douche apparatus 100 (or 100a) of FIG. 1A (or FIG. 1D) configured in a storage-orientation, wherein nozzle 102 (or nozzle 102a) may be inserted nozzle tip 106 (or 106a) end (i.e., distal end of nozzle 102 or 102a) first into a central portion of adapter assembly 120, also referred to as “adapter assembly central portion”, comprising bottle adapter 114, bottle adapter 116 and bottle adapter 118, thereby reducing the overall length of the storage-configuration depicted in FIG. 1E from that of a use-configuration depicted in FIG. 1A (or FIG. 1D), thereby enhancing its portability and the ability to carry douche apparatus 101, as shown in FIG. 1E or in a case (not shown in FIG. 1E), in a pants pocket, a shirt pocket, a back pack, a carrying bag or the like. A nozzle attachment feature of nozzle 102 (or 102a) (not visible in FIG. 1E) may be configured to mate with a mateable feature of bottle adapter 114 (not visible in FIG. 1E) at a nozzle attachment end 142 of adapter assembly 120 which is at the opposite end from a bottle attachment end 144 of adapter assembly 120.

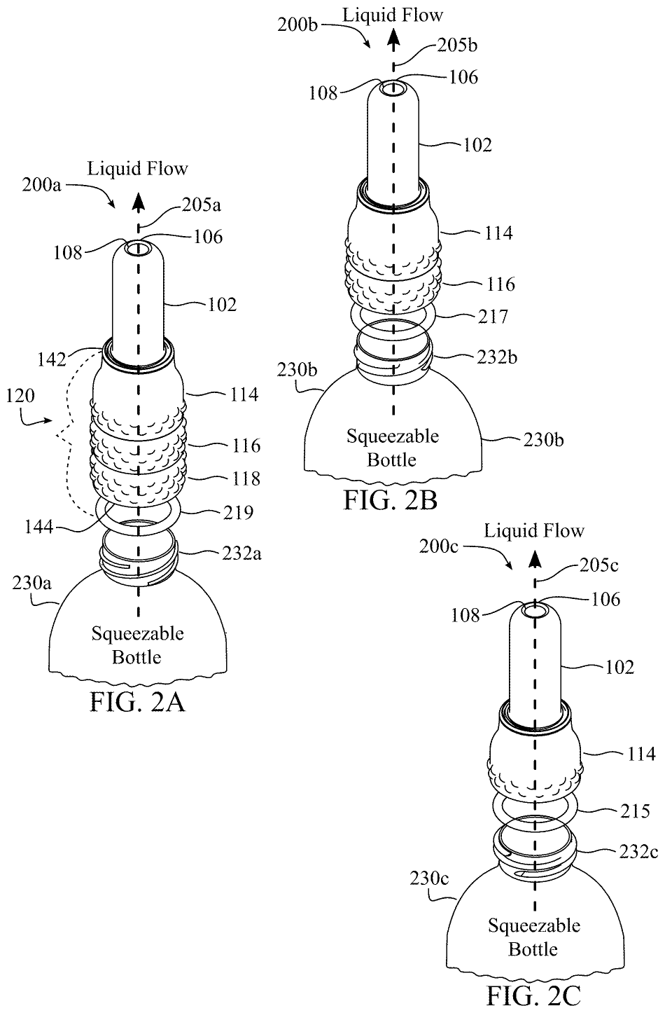

FIG. 2A, FIG. 2B and FIG. 2C depict partially exploded perspective views of douche apparatus 200a, douche apparatus 200b and douche apparatus 200c adapted to partially depicted squeezable bottles, i.e., squeezable bottle 230a, squeezable bottle 230b and squeezable bottle 230c, respectively, wherein a path and direction of liquid flow from squeezable bottle 230a, squeezable bottle 230b and squeezable bottle 230c through central portions of each bottle adapter and nozzle channels of douche apparatus 200a, douche apparatus 200b and douche apparatus 200c are indicated by arrow 205a, arrow 205b and arrow 205c, respectively. Douche apparatus 200a (which may correspond to douche apparatus 100 of FIG. 1A) comprising adapter assembly 120 and nozzle 102 which may be attached at its nozzle attachment end 142 and bottle attachment end 144 may be attached to bottle threads 232a of squeezable bottle 230a by mating bottle attachment threads (not visible in FIG. 2A) of bottle adapter 118, wherein an O-ring 219 may be seated in bottle adapter 118 and provide a liquid seal between apparatus 200a and squeezable bottle 230a. In some implementations, a rubber washer, gasket or other scaling member may be used instead of O-ring 219. Douche apparatus 200b (which may correspond to douche apparatus 100 of FIG. 1A having bottle adapter 118 and O-ring 219 removed) may be attached to male threads 232b of squeezable bottle 230b by mating female threads (not visible in FIG. 2B) of bottle adapter 116, wherein an O-ring 217 may be seated in bottle adapter 116 and provide a liquid seal between apparatus 200b and squeezable bottle 230b. In some implementations, a rubber washer, gasket or other sealing member may be used instead of O-ring 217. Douche apparatus 200c (which may correspond to douche apparatus 100 of FIG. 1A having bottle adapter 118, O-ring 219, bottle adapter 116 and O-ring 217 removed) may be attached to male threads 232c of squeezable bottle 230c by mating female threads (not visible in FIG. 2C) of bottle adapter 114, wherein an O-ring 215 may be seated in bottle adapter 114 and provide a liquid seal between apparatus 200c and squeezable bottle 230c. In some implementations, a rubber washer, gasket or other sealing member may be used instead of O-ring 215. In the example implementation of FIG. 2A, douche apparatus 200a may be douche apparatus 100 of FIG. 1A, wherein bottle adapter 118 comprises a first bottle attachment end configured to mate with bottle 230a having male threads 232a of a third type, bottle adapter 116 is configured to mate with squeezable bottle 230b (where bottle adapter 118 is detached from apparatus 100 exposing a second bottle attachment end as shown in FIG. 2B) having male threads 232b of a second type, and bottle adapter 114 is configured to mate with squeezable bottle 230c (where bottle adapter 118 and bottle adapter 116 are detached from apparatus 100 as shown in FIG. 2C exposing a third bottle attachment end) having male threads 232c of a first type, thereby enabling douche apparatus 100 of FIG. 1A to be adaptable to any bottle having a thread type of the third type (e.g. squeezable bottle 230a having threads 232a), second type (e.g. squeezable bottle 230b having threads 232b), or first type (e.g. squeezable bottle 230c having threads 232c). In some implementations, bottle threads of a third type may be compatible with a 1-liter Dasani brand water bottle. In some implementations, bottle threads of a second type may be compatible with a Poland Springs brand 1.5-liter water bottle, a Royal Farms Mountain Spring brand 1-liter water bottle and a Deer Park brand 1.5-liter water bottle. In some implementations, bottle threads of a first type may be compatible with a 0.5-liter Wellsley Farms brand water bottle. As will be apparent to those skilled in the art, in some implementations bottle adapter 114, bottle adapter 116 and bottle adapter 118 may be configured to be compatible with other types of bottle threads as those comprised by the aforementioned brands of water bottles, and such implementations are within the scope of the appended claims.

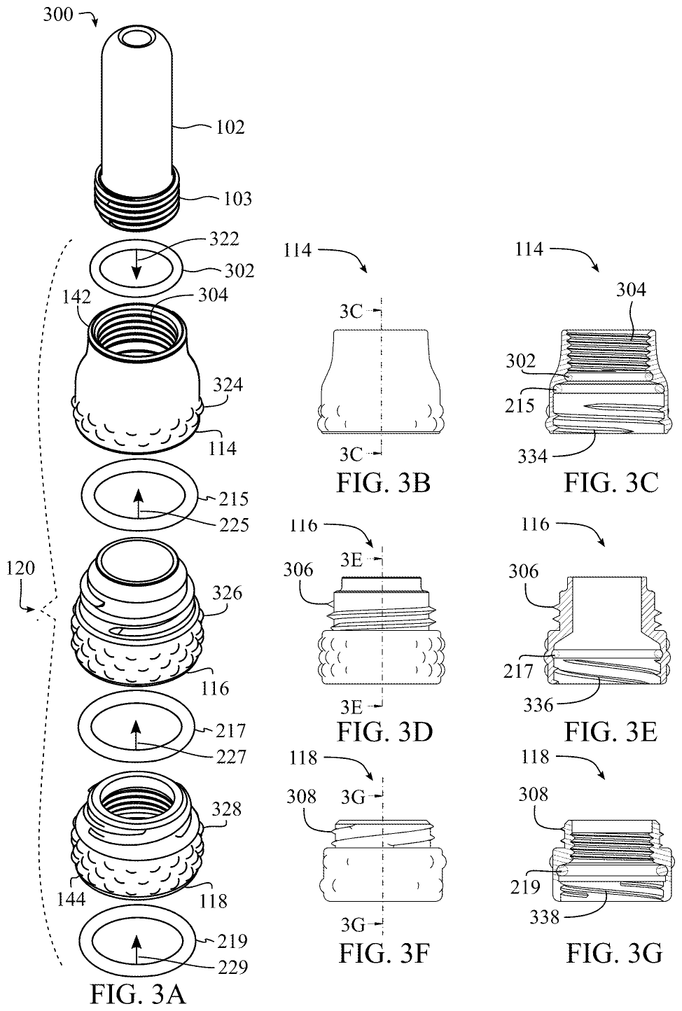

FIG. 3A, depicts a perspective view of an example exploded assembly 300 of a douche apparatus, such as douche apparatus 100 of FIG. 1A comprising a nozzle 102 having a nozzle attachment feature 103 at its proximal end which is configured to be mateable and removably attachable to adapter assembly 120 (shown in exploded view). Adapter assembly 120 may comprise one or more bottle adapters, such as bottle adapter 114, bottle adapter 116 and bottle adapter 118 as is shown in the example implementation depicted in FIG. 3A. Adapter assembly 120 may further comprise O-ring 302, O-ring 215, O-ring 217 and O-ring 219 which are not visible in views of adapter assembly 120 depicted in FIG. 1A, FIG. 1D, FIG. 1E and FIG. 2A. O-ring 302, O-ring 215, O-ring 217 and O-ring 219 are shown in relation to bottle adapter 114, bottle adapter 116 and bottle adapter 118, wherein each O-ring is depicted with an arrow directed to a bottle adapter in which they may first be seated prior to an assembly of adapter assembly 120 and an attachment of nozzle 102 thereto as shown in FIG. 1A which depicts a use-orientation of douche apparatus 100 (or 100a where nozzle 102a is substituted for nozzle 102). Namely, O-ring 215 may be seated in bottle adapter 114 as indicated by arrow 225, O-ring 217 may be seated in bottle adapter 116 as indicated by arrow 227, and O-ring 219 may be seated in bottle adapter 118 as indicated by arrow 229. O-ring 215 may provide a liquid seal between bottle adapter 114 and bottle adapter 116. O-ring 217 may provide a liquid seal between bottle adapter 116 and bottle adapter 118. O-ring 219 may provide a liquid seal between bottle adapter 118 and a liquid container comprising a threaded opening having male threads of a third type such as bottle 230a discussed above in conjunction with FIG. 2A. O-ring 302 may provide a liquid seal between nozzle 102 (or (102a) and bottle adapter 114 when seated in bottle adapter 114 (as indicated by arrow 322) and nozzle attachment feature 103 of nozzle 102 (or 102a) is mated with nozzle attachment end 142 comprising a mating feature matcable to nozzle attachment feature 103, such as threads 304 of bottle adapter 114 at a nozzle attachment end 142 of adapter assembly 120 (and bottle adapter 114 which forms portions of adapter assembly 120) opposite bottle attachment end 144, and seated against O-ring 302 in the orientation shown in FIG. 1A (and FIG. 1D). As will be apparent to those skilled in the art, in some implementations mating features other than threads depicted in nozzle attachment feature 103 and threads 304 are possible and within the scope of the appended claims, such as a bayonet mount or other such suitable mateable features. In some implementations, scaling members of other types than those of O-ring 302, O-ring 215, O-ring 217 and O-ring 219 may be used, such as rubber washers, gaskets and the like. In some implementations, nozzle attachment feature 103 and a mating feature of nozzle attachment end 142 may be a ½ inch male NPS (National Pipe Straight of the American National Standard Pipe Thread standard) thread and ½ inch female NPS thread, respectively, or in some implementations nozzle attachment feature 103 and a mating feature of nozzle attachment end 142 may be a ½ inch male BSP (British Standard Pipe standards) parallel thread and ½ inch female BSP parallel thread, respectively, or some other suitable thread.

Bottle adapter 114, bottle adapter 116 and bottle adapter 118 may comprise a plurality of nubs, such as nub 324, nub 326 and nub 328, respectively, which may facilitate a grip when assembling, disassembling, using and handling douche apparatus 100 (or 100a or 101). As will be apparent to those skilled in the art, many various forms of surface configurations may be implemented which may facilitate a grip, such as ridges, dimples, textures and the like. Preferably the surface configuration may be readily cleanable facilitating a user's thorough cleansing of the apparatus following use to minimize residual douching material, bacteria and the like.

FIG. 3A may be instructive in discussing a storage-configuration of douche apparatus 101, as is shown in FIG. 1E. Douche apparatus 100 (or 100a) is depicted in a use-configuration in FIG. 1A (and FIG. 1D), and the orientation of nozzle 102 (or 102a) is changed to a storage-configuration shown in FIG. 1E and referenced as douche apparatus 101. To assemble douche apparatus in a storage-configuration of FIG. 1E, tip 106 (or 106a) is inserted into a central portion of adapter assembly 120 and nozzle attachment feature 103 may be mated with a mateable feature of bottle adapter 114 (e.g., threads 304) such that nozzle 102 (or 102a) may be situated wholly in a central portion of adapter assembly 120 as depicted in FIG. 1E, or in some implementations, a portion of nozzle 102 (or 102a) beyond nozzle attachment feature 103 may be situated in a central portion of adapter assembly 120, such as may be the case where in some implementations, nozzle 102 (or 102a) may be longer than adapter assembly 120 and a portion of nozzle 102 (or 102a) necessarily extends beyond the length of adapter assembly 120.

As noted above, bottle adapter 118 may be configured for use with a liquid container comprising a threaded opening having male threads of a third type such as bottle 230a discussed above in conjunction with FIG. 2A. A use-configuration of douche apparatus 100 (or 100a) comprises adapter assembly 120 as depicted in FIG. 1A (or FIG. 1D), FIG. 2A and FIG. 3A. When attaching douche apparatus 100 (or 100a) to a liquid container comprising a threaded opening having male threads of a second type such as bottle 230b discussed above in conjunction with FIG. 2B, bottle adapter 118 is removed (along with O-ring 219 which may be seated therein) or are not present and bottle adapter 114 and bottle adapter 116 are configured (along with O-ring 302, O-ring 215 and O-ring 217 seated therein). When attaching douche apparatus 100 (or 100a) to a liquid container comprising a threaded opening having male threads of a first type such as bottle 230c discussed above in conjunction with FIG. 2C, bottle adapter 118 and bottle adapter 116 are removed (along with O-ring 219 and O-ring 217 which may be seated respectively therein) or are not present and bottle adapter 114 is configured (along with O-ring 302 and O-ring 215 seated therein).

FIG. 3B through FIG. 3G depict side elevation views and cross-sectional views of bottle adapter 114, bottle adapter 116 and bottle adapter 118 of the douche apparatus of FIG. 3A. FIG. 3B depicts a side elevation view of an example first bottle adapter 114 and indicates a section line 3C-3C. FIG. 3C depicts the indicated cross-section, wherein an attachment feature comprising female threads 304 (of a thread type configured to receive nozzle attachment feature 103 of nozzle 102) and female threads 334 of a first type are visible within the interior of bottle adapter 114. Also visible in FIG. 3C are an interior portion which may be called an “adapter central portion” though which a liquid may flow, and O-ring 302 and O-ring 215 seated within the interior of bottle adapter 114. FIG. 3D depicts a side elevation view of an example second bottle adapter 116, wherein male threads 306 of a first type are comprised by an adapter attachment end of bottle adapter 116 and are configured to mate with female threads 334 of a first type of bottle adapter 114. FIG. 3D indicates a section line 3E-3E. FIG. 3E depicts the indicated cross-section, wherein female threads 336 of a second type are visible within the interior of bottle adapter 116. Also visible in FIG. 3E are an interior portion which may be called an “adapter central portion” though which a liquid may flow, and O-ring 217 seated within the interior of bottle adapter 116. FIG. 3F depicts a side elevation view of an example third bottle adapter 118, wherein male threads 308 of a second type are comprised by an adapter attachment end of bottle adapter 118 and are configured to mate with female threads 336 of a second type of bottle adapter 116. FIG. 3F indicates a section line 3G-3G. FIG. 3G depicts the indicated cross-section, wherein female threads 338 of a third type are visible within the interior of bottle adapter 118. Also visible in FIG. 3E are an interior portion which may be called an “adapter central portion” though which a liquid may flow, and O-ring 219 seated within the interior of bottle adapter 118. One or more bottle adapters assembled in an adapter assembly such as adapter assembly 120, such as bottle adapter 114, bottle adapter 116 and bottle adapter 118 form a central portion of adapter assembly 120 which is comprised of central portions of bottle adapter 114, bottle adapter 116 and bottle adapter 118, wherein a liquid may flow through a central portion of adapter assembly 120 during use, and when not in use, a nozzle body, such as a portion of nozzle 102 extending from nozzle attachment feature 103 up to and including nozzle tip 106 (or 106a) of nozzle 102 (or 102a) may be situated wholly in a central portion of adapter assembly 120 as depicted in FIG. 1E, or in some implementations, a portion of nozzle 102 (or 102a) beyond nozzle attachment feature may be situated in a central portion of adapter assembly 120, such as may be the case where in some implementations, nozzle 102 (or 102a) may be longer than adapter assembly 120 and a portion of nozzle 102 (or 102a) extends beyond the length of adapter assembly 120.

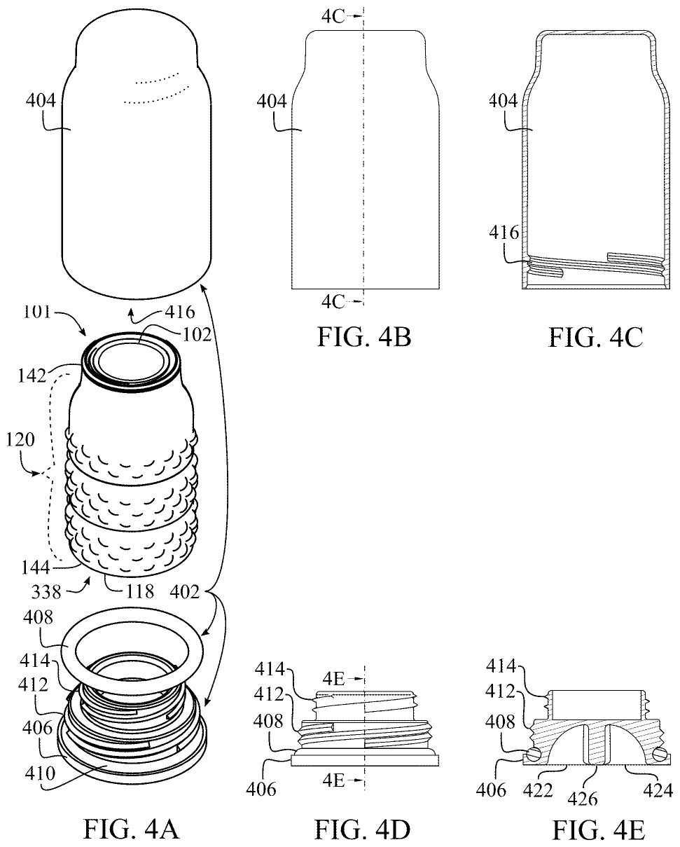

FIG. 4A depicts a perspective view of an example douche apparatus 101 in storage-orientation, such as that disclosed in conjunction with FIG. 1E (and which may be douche apparatus 100 of FIG. 1A reconfigured from a use-orientation to a storage-orientation), situated between components of a storage case 402 comprising a case housing 404, a case cap 406 and an O-ring 408, wherein storage case 402 is useable to store and transport douche apparatus 101. Case cap 406 comprises an interior side (visible in FIG. 4A) which is directed towards an interior of case housing 404 (not visible in FIG. 4A) when removably attached thereto and an exterior side (not visible in FIG. 4A) which is directed away from case housing 404 when removably attached thereto. To store douche apparatus 101, O-ring 408 may be seated in O-ring seat 410 of cap 406, female threads 338 (see FIG. 3G) of bottle adapter 118 comprised by adapter assembly 120 may be threaded onto male threads 414 of cap 406 thereby removably attaching bottle attachment end 144 (opposite from nozzle attachment end 142) of adapter assembly 120 of douche apparatus 101 to case cap 406, and male threads 412 of cap 406 may be threaded into female threads 416 (see FIG. 4C) of case housing 404, wherein O-ring 408 may provide a liquid seal between case cap 406 and case housing 404 such that douche apparatus 101 may be safely stored and remain clean within case 402 until required, despite being carried in a portable fashion, such as in a pants-pocket, bag, purse, backpack and the like. Following use, douche apparatus 101 may be returned to a storage-orientation and may be safely stored until a user may clean douche apparatus 101 and case 402 and store douche apparatus 101 within case 402 such that it is prepared for future use. Due to an attachment of douche apparatus 101 to case cap 406 and an attachment of case cap 406 to case housing 404, a rattling of douche apparatus 101 within case 402 may be prevented.

FIG. 4B depicts a side elevation view of case housing 404 of FIG. 4A and indicates a section line 4C-4C. FIG. 4C depicts the indicated cross-section, wherein female threads 416 of case housing 404 are configured to receive male threads 412 of case cap 406. FIG. 4D depicts a side elevation view of case cap 406 of FIG. 4A and indicates a section line 4E-4E. FIG. 4E depicts the indicated cross-section, wherein male threads 414 are configured to receive female threads 338 of bottle adapter 118 comprised by adapter assembly 120 and male threads 412 are configured to receive female threads 416 of case housing 404. Case cap 406 comprises a recess area 422 and a recess area 424 proximate to a graspable member 426, wherein a user may insert a thumb and finger into recess area 422 and recess area 424 and grasp case cap 406 by graspable member 426 to facilitate assembly and disassembly of douche apparatus 101 to case cap 406 and case cap 406 to case housing 404. In some implementations, recess area 422 and recess area 424 may be two recesses fully separated by graspable member 426; in some implementations, recess area 422 and recess area 424 may be two areas of a single recess having graspable member 526 situated therein (such as a raised three sided tab), or some other suitable configuration of one or more recesses and at least one graspable member.

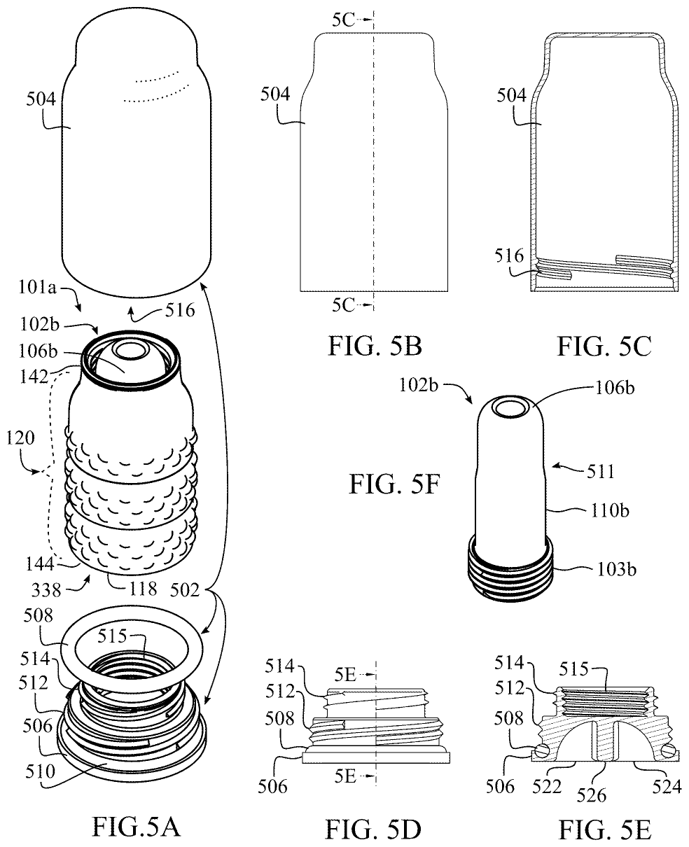

In some implementations, a douche apparatus may be configured such that a storage-orientation comprises a nozzle situated in a central portion of an adapter assembly with the nozzle nozzle tip directed outward from the nozzle attachment end. FIG. 5A depicts a perspective view of an example douche apparatus 101a in a storage-orientation comprising a nozzle 102b situated having nozzle tip 106b directed outward from nozzle attachment end 142 and a nozzle body which may be a portion of nozzle 102b extending from nozzle attachment feature 103b (see FIG. 5F) up to and including nozzle tip 106b, and the nozzle body may be wholly situated in a central portion of adapter assembly 120 as depicted in FIG. 5A, or in some implementations, a portion of nozzle 102b beyond a nozzle attachment feature may be situated in a central portion of adapter assembly 120, such as may be the case where in some implementations, nozzle 102b may be longer than adapter assembly 120 and a portion of nozzle 102b extends beyond the length of adapter assembly 120. In some implementations, nozzle 102b of douche apparatus 101a may be attached to case cap 506 which may in turn be attached to adapter assembly 120. Douche apparatus 101b may be situated between components of a storage case 502 comprising a case housing 504, a case cap 506 and an O-ring 508, wherein storage case 502 may be useable to store and transport douche apparatus 101a. To store douche apparatus 101a, nozzle attachment feature 103b (see FIG. 5F) of nozzle 102b may be mated to a corresponding attachment feature of case cap 506, such as female threads 515 of case cap 506, O-ring 508 may be seated in O-ring seat 510 of cap 506, and female threads 338 (see FIG. 3G) of bottle adapter 118 comprised by bottle attachment end 144 of adapter assembly 120 may be threaded onto male threads 514 of case cap 506 thereby removably attaching bottle attachment end 144 (opposite from nozzle attachment end 142) of adapter assembly 120 of douche apparatus 101a to case cap 506, and male threads 512 of cap 506 may be threaded into female threads (not visible in FIG. 5A) of case housing 504, wherein O-ring 508 may provide a liquid seal between case cap 506 and case housing 504 such that douche apparatus 101a may be safely stored and remain clean within case 502 until required, despite being carried in a portable fashion, such as in a pants-pocket, bag, purse, backpack and the like. Following use, douche apparatus 101a may be returned to a storage-orientation and may be safely stored until a user may clean douche apparatus 101a and case 502 and store douche apparatus 101a within case 502 such that it is prepared for future use. Due to an attachment of douche apparatus 101a to case cap 506 and an attachment of case cap 506 to case housing 504, a rattling of douche apparatus 101a within case 502 may be prevented.

FIG. 5B depicts a side elevation view of case housing 504 of FIG. 5A and indicates a section line 5C-5C. FIG. 5C depicts the indicated cross-section, wherein female threads 516 are configured to receive male threads 512 of case cap 506. FIG. 5D depicts a side elevation view of case cap 506 of FIG. 5A and indicates a section line 5E-5E. FIG. 5E depicts the indicated cross-section, wherein an attachment feature, such as female threads 515 are configured to receive nozzle attachment feature 103b of nozzle 102b (see FIG. 5F), male threads 514 are configured to receive female threads 338 of bottle adapter 118 comprised by adapter assembly 120 and male threads 512 are configured to receive female threads 516 of case housing 504. Case cap 506 comprises a recess area 522 and a recess area 524 proximate to a graspable member 526, wherein a user may insert a thumb and finger into the recess area 522 and recess area 524 and grasp case cap 506 by graspable member 526 to facilitate assembly and disassembly of douche apparatus 101a to case cap 506 (wherein nozzle 102b and adapter assembly 120 are each removably attachable to case cap 506) and case cap 506 to case housing 504. In some implementations, recess area 522 and recess area 524 may be formed by two separate recesses, each comprising a recess area fully separated by graspable member 526; in some implementations, recess area 522 and recess area 524 may be two recess areas of a single recess having graspable member situated therein (such as a raised three sided tab), or some other suitable configuration of one or more recesses and at least one graspable member.

FIG. 5F depicts a perspective view of an example implementation of nozzle 102b comprising a nozzle wall 110b, wherein nozzle wall 110b may have a taper 511 to a smaller diameter such that the upper portion of nozzle 102b may pass within/through O-ring 302 of bottle adapter 114 (see FIG. 3C). In some implementations, wall 110b may be of a uniform diameter configured to pass within/through O-ring 302. A nozzle body may be a portion of nozzle 102b extending from nozzle attachment feature 103b up to and including nozzle tip 106b.

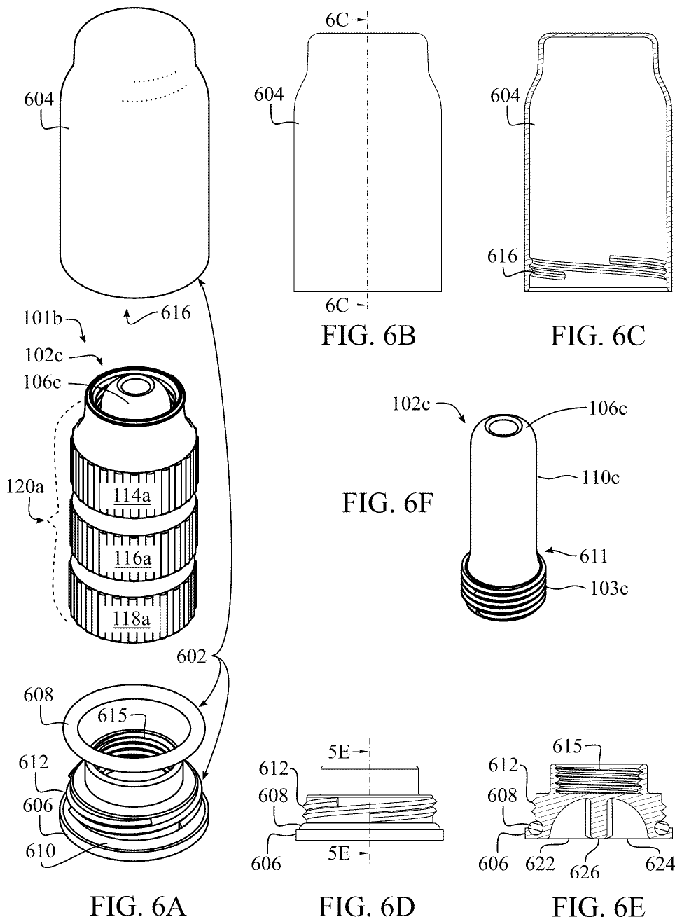

In some implementations, a douche apparatus may comprise one or more bottle adapters which do not mate with each other (e.g., do not interlock) as do bottle adapter 114, bottle adapter 116 and bottle adapter 118 in adapter assembly 120 disclosed in conjunction with FIGS. 3A-3G. FIG. 6A depicts a perspective view of an example douche apparatus 101b of the present invention comprising three bottle adapters, wherein FIG. 6A depicts douche apparatus 101b in a storage-orientation comprising a nozzle 102c situated having nozzle tip 106c directed outward from adapter assembly 120a and a nozzle body which may be a portion of nozzle 102c extending from nozzle attachment feature 103c (see FIG. 6F) up to and including nozzle tip 106c, and the nozzle body may be wholly situated in a central portion of adapter assembly 120a as depicted in FIG. 6A, or in some implementations, a portion of nozzle 102c beyond a nozzle attachment feature 103c may be situated in a central portion of adapter assembly 120, such as may be the case where in some implementations, nozzle 102c may be longer than adapter assembly 120 and a portion of nozzle 102c extends beyond the length of adapter assembly 120. Douche apparatus 101b is depicted in a storage-orientation comprising a nozzle 102c situated in a central portion of an adapter assembly 120a having nozzle tip 106c directed upward. Bottle adapter 114a, bottle adapter 116a and bottle adapter 118a may be arranged in a stack and may not be secured together. Douche apparatus 101b may be situated between components of a storage case 602 comprising a case housing 604, a case cap 606 and an O-ring 608, wherein storage case 602 is useable to store and transport douche apparatus 101b. To store douche apparatus 101b, a nozzle attachment feature 103c (see FIG. 6F) of nozzle 102c may mated with an attachment feature of case cap 606, such as female threads 615, bottle adapter 118a, bottle adapter 116a and bottle adapter 114a may be stacked on case cap 606 with nozzle 102c passing through central portions thereof, O-ring 608 may be seated in O-ring seat 610 of cap 606, and male threads 612 of cap 606 may be threaded into female threads 616 (see FIG. 6C) of case housing 604, wherein O-ring 608 may provide a liquid seal between case cap 606 and case housing 604 such that douche apparatus 101b may be safely stored and remain clean within case 602 until required, despite being carried in a portable fashion, such as in a pants-pocket, bag, purse, backpack and the like. Following use douche apparatus 101b may be returned to a storage-orientation and may be safely stored until a user may clean douche apparatus 101b and case 602 and store douche apparatus 101b within case 602 such that it may be prepared for future use.

FIG. 6B depicts a side elevation view of case housing 604 of FIG. 6A and indicates a section line 6C-6C. FIG. 6C depicts the indicated cross-section, wherein female threads 616 are configured to receive male threads 612 of case cap 606. FIG. 6D depicts a side elevation view of case cap 606 of FIG. 6A and indicates a section line 6E-6E. FIG. 6E depicts the indicated cross-section, wherein an attachment feature, such as female threads 615 are configured to receive nozzle attachment feature 103c of nozzle 102c (see FIG. 6F) and male threads 612 are configured to receive female threads 616 of case housing 604. Case cap 606 comprises a recess area 622 and a recess area 624 proximate to a graspable member 626, wherein a user may insert a thumb and finger into the recess area 622 and recess area 624 and grasp case cap 606 by a graspable member 626 to facilitate assembly and disassembly of douche apparatus 101b to case cap 606 and case cap 606 to case housing 604. In some implementations, recess area 624 and recess area 624 may be two recesses fully separated by graspable member 626; in some implementations, recess area 622 and recess area 624 may be two areas of a single recess having graspable member 626 situated therein (such as a raised three sided tab), or some other suitable configuration of one or more recesses and at least one graspable member

FIG. 6F depicts a perspective view of an example implementation of nozzle 102c comprising a nozzle attachment feature 103c configured to mate with an attachment feature, such as threads 615 of case cap 606, and a nozzle wall 110c, wherein nozzle wall 110c may have a taper 611 to a smaller diameter such that an upper portion of nozzle 102c may pass within/through bottle adapter 114a, bottle adapter 116a and bottle adapter 118a. In some implementations, wall 110c may be of a uniform diameter configured to pass within/through bottle adapter 114a, bottle adapter 116a and bottle adapter 118a.

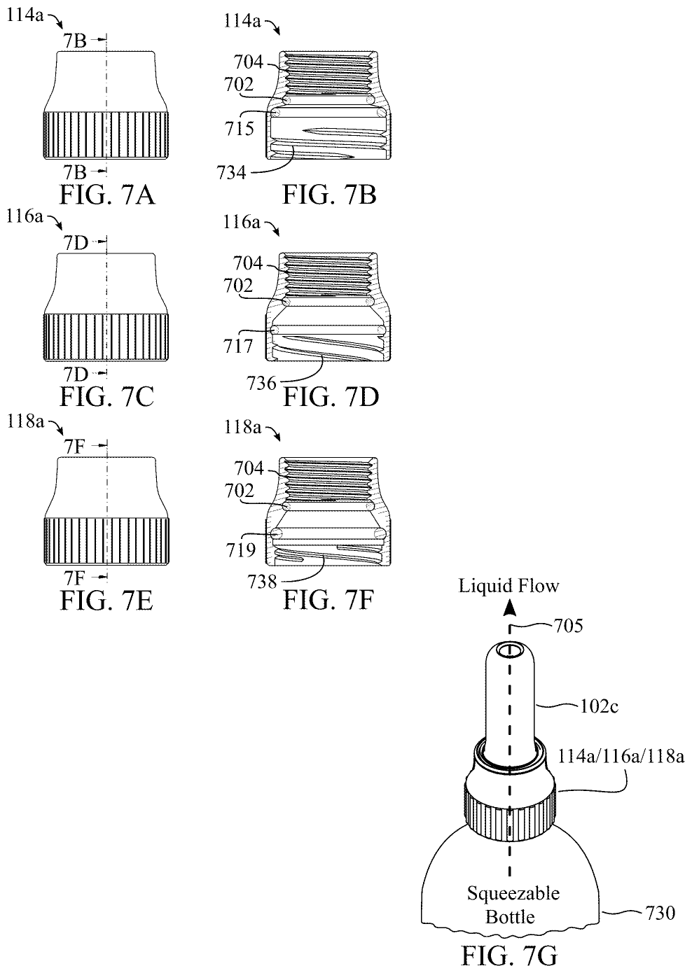

FIG. 7A through FIG. 7F depict side elevation views and cross-sectional views of bottle adapter 114a, bottle adapter 116a and bottle adapter 118a. FIG. 7A depicts a side elevation view of a first bottle adapter 114a of the douche apparatus of FIG. 6A and indicates a section line 7B-7B. FIG. 7B depicts the indicated cross-section, wherein an attachment feature, such as female threads 704 are configured to nozzle attachment feature 103c of nozzle 102c (see FIG. 6F) and female threads 734 of a first type compatible with a bottle comprising male threads of a first type (such as threads 232c of FIG. 2C) are visible within the interior of bottle adapter 114a. Also visible in FIG. 7B are nozzle O-ring 702 and bottle O-ring 715 seated within the interior of bottle adapter 114a. FIG. 7C depicts a side elevation view of a second bottle adapter 116a of the douche apparatus of FIG. 6A and indicates a section line 7D-7D. FIG. 7D depicts the indicated cross-section, wherein an attachment feature, such as female threads 704 configured to mate with nozzle attachment feature 103c of nozzle 102c (see FIG. 6F) and female threads 736 of a second type compatible with a bottle comprising male threads of a second type (such as threads 232b of FIG. 2B) are visible within the interior of bottle adapter 116a. Also visible in FIG. 7D are nozzle O-ring 702 and bottle O-ring 717 seated within the interior of bottle adapter 116a. FIG. 7E depicts a side elevation view of a third bottle adapter 118a of the douche apparatus of FIG. 6A and indicates a section line 7F-7F. FIG. 7F depicts the indicated cross-section, wherein an attachment feature, such as female threads 704 configured to mate with nozzle attachment feature 103c of nozzle 102c (see FIG. 6F) and female threads 738 of a third type compatible with a bottle comprising male threads of a third type (such as threads 232a of FIG. 2A) are visible within the interior of bottle adapter 118a. Also visible in FIG. 7F are nozzle O-ring 702 and bottle O-ring 719 seated within the interior of bottle adapter 118a.

FIG. 7G depicts a partial perspective view of a squeezable bottle 730, such as a conventional plastic water bottle, having an attached douche apparatus of FIG. 6A, such as douche apparatus 101b configured for use and comprising a bottle adapter which may be one of 114a, 116a and 118a and may be representative of a bottle comprising a thread of one of a first type, a second type and a third type, respectively, such as bottles depicted in FIG. 2C, FIG. 2B and FIG. 2A, respectively, having threads 232c, threads 232b and threads 232a, respectively. When assembled as shown in FIG. 7G, nozzle O-ring 702 and bottle O-ring 715, nozzle O-ring 702 and bottle O-ring 717, or nozzle O-ring 702 and bottle O-ring 719 of bottle adapter 114a, bottle adapter 116a or bottle adapter 118a, respectively, may provide liquid seals between a bottle, such as example squeezable bottle 730 having threads of a first type, second type or third type, respectively, and when filled with a liquid and squeezed, liquid may flow from squeezable bottle 730 through a central portion of bottle adapter 114a, bottle adapter 116a or bottle adapter 118a, respectively, and through a channel of nozzle 102c and be dispensed from an orifice of nozzle 102c as indicated by arrow 705 indicating a path and flow of liquid.

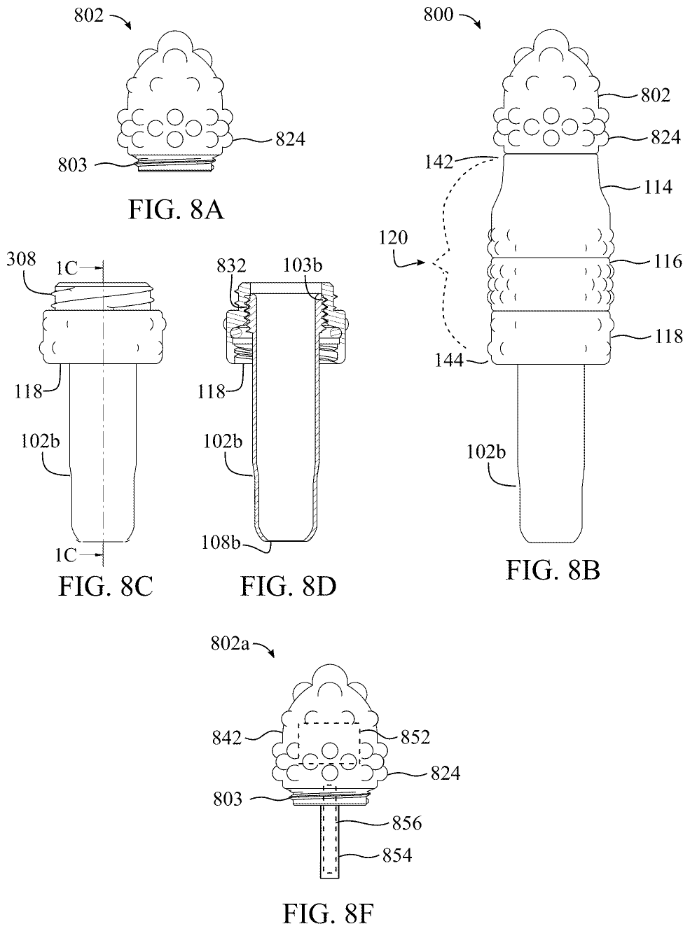

In some implementations, a douche apparatus, such as douche apparatus 100 (or 100a) may further comprise a stimulation device which may be removably attached to an adapter assembly, such as adapter assembly 120 of FIG. 3A, as a sexual stimulation apparatus. FIG. 8A depicts a side elevation view of an example stimulation device 802 comprising a plurality of nubs, such as nub 824 and a device attachment feature 803 which may be configured to mate with nozzle attachment end 142 of adapter assembly 120 (FIG. 3A). FIG. 8B depicts a side elevation view of an example douche apparatus 800 of the present invention further comprising a stimulation device 802, wherein stimulation device 802 is attached to adapter assembly 120 at nozzle attachment end 142. In some implementations, bottle adapter 118 may be configured to removably attach to a nozzle, such as nozzle 102b (see FIG. 5F) which may serve as a handle for douche apparatus 800, wherein FIG. 8C and FIG. 8D depict a side elevation of bottle adapter 118 and nozzle 102b indicating a section line and a side elevation of the indicated cross-section, respectively, and such cross-section of FIG. 8D shows an attachment feature, such as threads 832 mateable to a nozzle attachment feature 103b. In some implementations, an elongated storage case such as a longer implementation of storage case 502 (see FIG. 5A) which may be increased in length by an amount sufficient to allow storage of stimulation apparatus 800 and a nozzle, such as nozzle 102b (FIG. 5A) situated within a central portion of adapter assembly 120, wherein both nozzle 102b and adapter assembly 120 (comprising stimulation device 802) may be attached to case cap 506 as disclosed in conjunction with FIG. 5A.

In some implementations, a stimulation cap may be an electromechanical device comprising a vibrator mechanism and a power source for powering the vibrator mechanism. FIG. 8F depicts a stimulation device 802a having a plurality of nubs on an upper portion 842, such as nub 824, a vibrator mechanism 852, a battery housing 854 and a battery 856 within battery housing 854 configured to power vibrator mechanism 852. In some implementations, a rotation of battery housing 854 relative to upper portion 842 may cause completion of a circuit between battery 856 and vibrator mechanism 852, such that battery housing 854 may function as a switch usable to turn on and turn off vibrator mechanism 852. In some implementations, battery housing 854 may be configured to fit through an orifice 108b of nozzle 102b and be situated at least partially within a nozzle body of nozzle 102b when stimulation apparatus 800 is assembled in a storage-configuration.

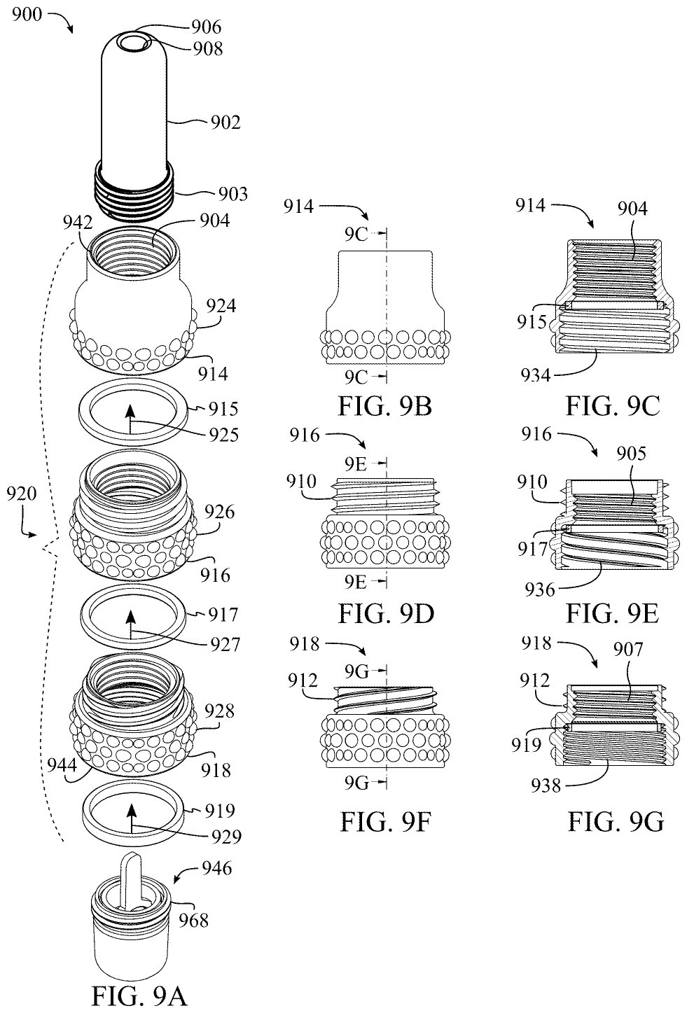

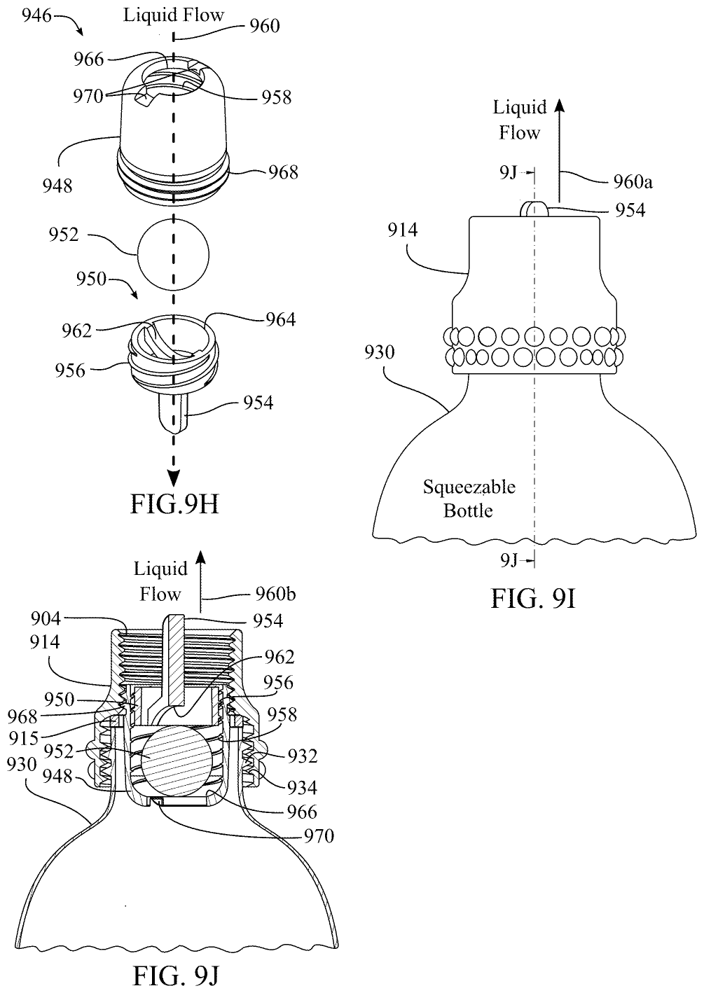

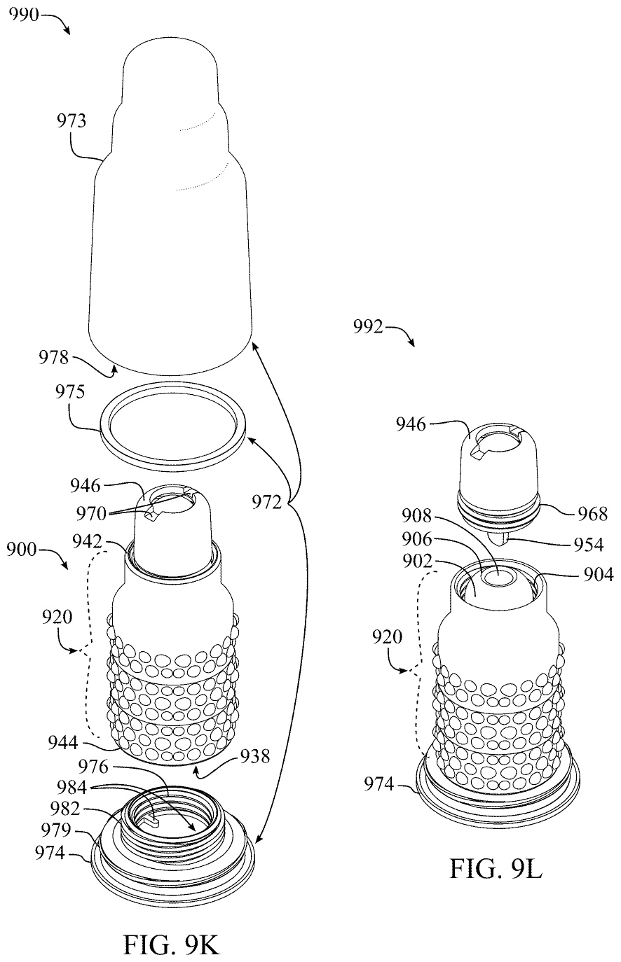

In some implementations, a douche apparatus, such as douche apparatus 100 (or 100a) may further comprise a check valve which may be removably attached to an adapter assembly comprising one or more interlocked bottle adapters, similar to adapter assembly 120 of FIG. 3A, or an individual bottle adapter similar to bottle adapters 114a, 116a, 118a of adapter assembly 120a of FIG. 6A, to allow liquid to flow through the adapter assembly and a nozzle attached thereto and dispense through an orifice, and to prevent liquid from flowing in a reverse direction thereof, thereby preventing dispensed liquid from being drawn back into an attached liquid container, such as an attached squeezable plastic water bottle. FIG. 9A depicts a perspective view of an example partially exploded assembly of a douche apparatus 900 comprising a nozzle 902 having a nozzle attachment feature 903 and a nozzle tip 906 having an orifice 908, and a check valve 946 (not shown in an exploded view in FIG. 9A) having a check valve attachment feature 968, wherein nozzle attachment feature 903 and check valve attachment feature 968 are configured to be mateable and removably attachable to an adapter assembly 920 (shown in an exploded view in FIG. 9A). Adapter assembly 920 may comprise one or more bottle adapters, such as bottle adapter 914, bottle adapter 916 and bottle adapter 918 as is shown in the example implementation depicted in FIG. 9A. Adapter assembly 920 may further comprise a washer 915, a washer 917 and a washer 919, wherein washer 915, washer 917 and washer 919 are shown in relation to bottle adapter 914, bottle adapter 916 and bottle adapter 918, and each washer is depicted with an arrow directed to a bottle adapter in which they may first be seated prior to an assembly of adapter assembly 920 and an attachment of nozzle 902 thereto similar to that as shown for apparatus 100 in FIG. 1A which depicts a use-orientation of douche apparatus 100 (or 100a where nozzle 102a is substituted for nozzle 102). Namely, washer 915 may be seated in bottle adapter 914 as indicated by arrow 925, washer 917 may be seated in bottle adapter 916 as indicated by arrow 927, and washer 919 may be seated in bottle adapter 918 as indicated by arrow 929. Washer 915 may provide a liquid seal between bottle adapter 914 and bottle adapter 916. Washer 917 may provide a liquid seal between bottle adapter 916 and bottle adapter 918. Washer 919 may provide a liquid seal between bottle adapter 918 and a liquid container comprising a threaded opening having male threads of a third type such as bottle 230a discussed above in conjunction with FIG. 2A. Nozzle attachment feature 903 of nozzle 902 may be mated with nozzle attachment end 942 comprising a mating feature mateable to nozzle attachment feature 903, such as threads 904 of bottle adapter 914 at a nozzle attachment end 942 of adapter assembly 920 (and bottle adapter 914 which forms portions of adapter assembly 920) opposite a bottle attachment end 944. Each bottle adapter, i.e., bottle adapter 914, bottle adapter 916 and bottle adapter 918, may comprise a bottle attachment end and may be configured to attach at least a portion of douche apparatus 900 comprising nozzle 902 to a bottle of compatible threads to that of the bottle attachment end. A bottle may be a flexible sided container (e.g., a squeezable bottle) comprising a volume of liquid, such as for example, a conventional plastic water bottle comprising water. When using water, such as that found in a conventional plastic water bottle, a user may choose to add salt to produce a saline solution or choose to add some other desired additive prior to douching. As will be apparent to those skilled in the art, in some implementations mating features other than threads depicted in nozzle attachment feature 903 and threads 904 are possible and within the scope of the appended claims, such as a bayonet mount or other such suitable mateable features. In some implementations, scaling members of other types than those of washer 915, washer 917 and washer 919 may be used, such as O-rings, gaskets and the like. In some implementations, nozzle attachment feature 903 and a mating feature of nozzle attachment end 942 may be a ½ inch male NPS (National Pipe Straight of the American National Standard Pipe Thread standard) thread and ½ inch female NPS thread, respectively, or in some implementations nozzle attachment feature 903 and a mating feature of nozzle attachment end 942 may be a ½ inch male BSP (British Standard Pipe standards) parallel thread and ½ inch female BSP parallel thread, respectively, or some other suitable thread. In some implementations a sealing member, such as a washer, O-ring, gasket or the like may be used to provide a liquid seal between nozzle 902 and threads 904 of bottle adapter 914 of adapter assembly 920, similar to O-ring 302 shown in FIG. 3A. However, in some implementations, a small amount of leakage about the mating area between nozzle attachment feature 903 and threads 904 that may be present during use may not justify the added cost and/or time required to implement, assemble, clean, etc. a sealing member between nozzle 902 and bottle adapter 914 needed to prevent all potential leakage therebetween.

Bottle adapter 914, bottle adapter 916 and bottle adapter 918 may comprise a plurality of nubs, such as nub 924, nub 926 and nub 928, respectively, which may facilitate a grip when assembling, disassembling, cleaning, using and handling douche apparatus 900. As will be apparent to those skilled in the art, many various forms of surface configurations may be implemented which may facilitate a grip, such as ridges, dimples, textures and the like. Preferably the surface configuration may be readily cleanable facilitating a user's thorough cleansing of the apparatus following use to minimize residual douching material, bacteria and the like.

FIG. 9B through FIG. 9G depict side elevation views and cross-sectional views of bottle adapter 914, bottle adapter 916 and bottle adapter 918 of the douche apparatus 900 of FIG. 9A. FIG. 9B depicts a side elevation view of an example first bottle adapter 914 and indicates a section line 9C-9C. FIG. 9C depicts the indicated cross-section, wherein an attachment feature comprising female threads 904 (of a thread type configured to receive nozzle attachment feature 903 of nozzle 902 and check valve attachment feature 968 of check valve 946) and female threads 934 of a first type are visible within the interior of bottle adapter 914. Also visible in FIG. 9C are an interior portion which may be called an “adapter central portion” though which a liquid may flow, and washer 915 seated within the interior of bottle adapter 914. FIG. 9D depicts a side elevation view of an example second bottle adapter 916, wherein male threads 910 of a first type are comprised by an adapter attachment end of bottle adapter 916 and are configured to mate with female threads 934 of a first type of bottle adapter 914. FIG. 9D indicates a section line 9E-9E. FIG. 9E depicts the indicated cross-section, wherein an attachment feature comprising female threads 905 of a thread type configured to receive check valve attachment feature 968 of check valve 946, and female threads 936 of a second type are visible within the interior of bottle adapter 916. Also visible in FIG. 9E are an interior portion which may be called an “adapter central portion” though which a liquid may flow, and washer 917 seated within the interior of bottle adapter 916. FIG. 9F depicts a side elevation view of an example third bottle adapter 918, wherein male threads 912 of a second type are comprised by an adapter attachment end of bottle adapter 918 and are configured to mate with female threads 936 of a second type of bottle adapter 916. FIG. 9F indicates a section line 9G-9G. FIG. 9G depicts the indicated cross-section, wherein an attachment feature comprising female threads 907 of a thread type configured to receive check valve attachment feature 968 of check valve 946, and female threads 938 of a third type are visible within the interior of bottle adapter 918. Also visible in FIG. 9E are an interior portion which may be called an “adapter central portion” though which a liquid may flow, and washer 919 seated within the interior of bottle adapter 918. One or more bottle adapters assembled in an adapter assembly such as adapter assembly 920, such as bottle adapter 914, bottle adapter 916 and bottle adapter 918 form a central portion of adapter assembly 920 which is comprised of central portions of bottle adapter 914, bottle adapter 916 and bottle adapter 918, wherein a liquid may flow through a central portion of adapter assembly 920 during use, and when not in use, douche apparatus 900 may be configured in a storage configuration, wherein a nozzle body, such as a portion of nozzle 902 extending from nozzle attachment feature 903 up to and including nozzle tip 906 of nozzle 902 may be situated wholly in a central portion of adapter assembly 920 as depicted in FIG. 9L, or in some implementations, a portion of nozzle 902 beyond nozzle attachment feature may be situated in a central portion of adapter assembly 920, such as may be the case where in some implementations, nozzle 902 may be longer than adapter assembly 920 and a portion of nozzle 902 extends beyond the length of adapter assembly 920.

Bottle adapter 918 may be configured for use with a liquid container comprising a threaded opening having male threads of a third type such as bottle 230a discussed above in conjunction with FIG. 2A. A use-configuration of douche apparatus 900 of FIG. 9A comprises adapter assembly 920 having nozzle 902 attached thereto similar to adapter assembly 120 and nozzle 102 as depicted in FIG. 1A and FIG. 2A. When attaching douche apparatus 900 to a liquid container comprising a threaded opening having male threads of a second type such as bottle 230b discussed above in conjunction with FIG. 2B, bottle adapter 918 is removed or is not present and bottle adapter 914 and bottle adapter 916 are configured (along with washer 915 and washer 917 seated therein, respectively). When attaching douche apparatus 900 to a liquid container comprising a threaded opening having male threads of a first type such as bottle 230c discussed above in conjunction with FIG. 2C, bottle adapter 918 and bottle adapter 916 are removed or are not present and bottle adapter 914 is configured along with washer 915 seated therein.

FIG. 9H depicts an exploded perspective view of an example implementation of check valve 946, comprising a check valve body 948 having check valve attachment feature 968, orifice 966, slot(s) 970 and check valve cap attachment threads 958, ball 952 and check valve cap 950 comprising ball saddle 962, cap opening 964, cap attachment feature 956 and tab 954. Each of the three bottle adapters of bottle adapter assembly 920 comprise, within central portions thereof, female threads of a thread type configured to receive check valve attachment feature 968 of check valve 946, wherein bottle adapter 914 comprises female threads 904 configured to receive check valve attachment feature 968 of check valve 946, bottle adapter 916 comprises female threads 905 configured to receive check valve attachment feature 968 of check valve 946 and bottle adapter 918 comprises female threads 907 configured to receive check valve attachment feature 968 of check valve 946. Douche apparatus 900 may be configured to attach to three different types of bottle threads by virtue of its three bottle adapters, bottle adapter 914, bottle adapter 916 and bottle adapter 918, wherein none, one or two bottle adapters may be removed from bottle adapter assembly 920 such that the lowest configured bottle adapter at the distal end from nozzle 902 comprises a desired bottle attachment thread type, and given that each bottle adapter is configured to receive and mate with check valve attachment feature 968, the lowest configured bottle adapter may be configured with check valve 946 attached thereto, thereby providing for a dispensing flow of liquid (e.g., in the direction indicated by arrow 960 indicating a direction of liquid flow through check valve 946) through attached bottle adapters and nozzle, and preventing a return flow in the opposite direction of a dispensing flow. The assembly and operation of check valve 946 is further discussed below in conjunction with FIG. 9I and FIG. 9J.

FIG. 9I depicts a partial side view of a squeezable bottle 930 with portions of douche apparatus 900 attached thereto, namely bottle adapter 914 configured with check valve 946 attached thereto, wherein tab 954 of check valve 946 is partially visible. In use, nozzle 102 may be attached to bottle adapter 914 and a liquid present in bottle 930 may be dispensed in the direction of flow indicated by arrow 960a upon squeezing bottle 930. FIG. 9I further comprises section line 9J-9J, wherein FIG. 9J depicts the indicated cross section. FIG. 9J shows the interoperation and mating among bottle 930, bottle adapter 914 and check valve 946 and its various component parts, namely check valve body 948, ball 952 and check valve cap 950. A bottle adapter, such as bottle adapter 914, and check valve are assembled together by positioning check valve 946 at a bottle attachment end of a bottle adapter or a bottle adapter assembly, such as in this example of bottle adapter 914 depicted in FIG. 9J, and mating (i.e., threading together by rotating check valve 946 relative to the example bottle adapter 914) check valve attachment feature 968 to threads 904 of bottle adapter 914. The bottle adapter-check valve assembly is mated with bottle 930 by threading threads 934 of a first type of bottle adapter 914 onto bottle threads 932 of a first type of bottle 930, wherein washer 915 forms a seal under compressive force between bottle adapter 914 and bottle 930. Similarly, should bottle 930 have threads of a second type, bottle adapter 916 would be mated to bottle adapter 914 and check valve 946 attachment feature 968 would be mated to threads 905 of bottle adapter 916 (see FIG. 9E) which would in turn be threaded onto bottle 930, wherein washer 917 forms a seal under compressive force between bottle adapter 916 and bottle 930. Similarly, should bottle 230 have threads of a third type, bottle adapter 916 would be mated to bottle adapter 914, bottle adapter 918 would be mated to bottle adapter 916 and check valve 946 attachment feature 968 would be mated to threads 907 of bottle adapter 918 (see FIG. 9G) which would in turn be threaded onto bottle 930, wherein washer 919 forms a seal under compressive force between bottle adapter 918 and bottle 930.

Check valve 946 is assembled by first positioning ball 952 inside check valve body 948 and threading attachment feature 956 of check valve cap 950 into threads 958 of check valve body 948 by grasping tab 954 and rotating check valve cap 950 relative to check valve body 948 accordingly. In FIG. 9J, ball 952 is shown suspended between orifice 966 and saddle 962. In normal operation and in the depicted orientation, barring any liquid flow in the direction indicated by arrow 960b, gravity would cause ball 952 to settle against orifice 966. If a vacuum force was generated within bottle 930, such as may occur when liquid has been dispensed by a squeezing of bottle 930 and then such squeezing is terminated, the higher-pressure side exterior to bottle 930 may force ball 952 against orifice 966 thereby sealing orifice 966 regardless of the orientation of bottle 930 and preventing a reverse flow of liquid (i.e., a backflow of liquid flow in the opposite direction indicated by arrow 960b) into bottle 930. Also shown in FIG. 9J is slot(s) 970 which may be used in conjunction with a storage case cap to assist in attaching (or detaching) check valve 946 to a bottle adapter or bottle adapter assembly, as will be discussed in conjunction with FIG. 9K.

FIG. 9K depicts a partially exploded perspective view 990 of douche apparatus 900 assembled in a storage configuration situated between components of a storage case 972 comprising a case housing 973, a case cap 974 and a case washer 975, with nozzle 902, which would normally be present, not shown to allow visibility of features of case cap 974. Storage case 972 is useable to store and transport douche apparatus 900. Case cap 974 comprises an interior side (visible in FIG. 9K) which is directed towards an interior of case housing 973 (the interior not visible in FIG. 9K) when removably attached thereto. The interior side of case cap 974 comprises case cap threads 979 which are mateable to threads 978 (not visible in FIG. 9K) of case housing 973, threads 982 mateable to threads 938 of bottle adapter assembly 920, threads 976 mateable to nozzle attachment feature 903, and tab(s) 984 useable to mate with slot(s) 970 of check valve 946 such that case cap 974 may be used as an assembly tool (and disassembly tool) to removably attach check valve 946 at a bottle attachment end of a bottle adapter or a bottle adapter assembly. Case cap 974 further comprises an exterior side not visible in FIG. 9K which is directed away from case housing 973 when removably attached thereto. In some implementations, the exterior side of case cap 974 may be the same or similar to that of case cap 506 of FIG. 5E or case cap 606 of FIG. 6E. In some implementations, case cap 974 may comprise, the same or similar features to the following of case cap 506 (or 606): a recess area 522 (or 622) and a recess area 524 (or 624) proximate to a graspable member 526 (or 626), wherein a user may insert a thumb and finger into the recess area that is the same or similar to recess area 522 (or 622) and the recess area that is the same or similar to recess area 524 (or (624) and grasp case cap 974 by the graspable member that is the same or similar to graspable member 526 (or 626) to facilitate assembly and disassembly of douche apparatus 900 and case 972. In some implementations, recess areas may be formed by two separate recesses, each comprising a recess area fully separated by a graspable member; in some implementations, recess areas may be two recess areas of a single recess having graspable member situated therein (such as a raised three-sided tab), or some other suitable configuration of one or more recesses and at least one graspable member. To use case cap 974 as an assembly tool to removably attach check valve 946 at a bottle attachment end of a bottle adapter or bottle adapter assembly, such as bottle adapter 914 as depicted in FIG. 9J, a user can position check valve 946 in case cap 974 such that slot(s) 970 mate with tab(s) 984 thereby preventing a rotation of check valve 946 relative to case cap 974. A user may then grasp case cap by the graspable member discussed above, position check valve 946 at bottle attachment end of bottle adapter 914 and mate (i.e., thread together by rotating check valve 946 relative to the example bottle adapter 914) check valve attachment feature 968 to threads 904 of bottle adapter 914 by rotating the graspable member of case cap 974 which causes check valve 946 positioned thereon to rotate relative to the bottle attachment end of bottle adapter 914. Case cap 974 may also be used in a reverse fashion as a disassembly tool to remove check valve 946 at a bottle attachment end of a bottle adapter or bottle adapter assembly.

FIG. 9L depicts a perspective view of douche apparatus 900 in a storage configuration and assembled to case cap 974 with check valve 946 removed to show nozzle 902 in its storage configuration. To store douche apparatus 900 in case 972, case washer 975 may be positioned on case cap 974 (or seated in case housing 973), nozzle attachment feature 903 may be attached to threads 976 of case cap 974 and threads 938 of adapter assembly 920 (and also of bottle adapter 918) may be attached to threads 982 of case cap 974 thereby positioning nozzle 902 within a central portion of adapter assembly 920 for storage and thereby reducing the overall form factor of douche apparatus 900 for storage. Tab 954 of check valve 946 may be positioned to extend into orifice 908 disposed in nozzle tip 906 of nozzle 902 and check valve attachment feature 968 may be threaded into threads 904 of adapter assembly 920 (and also bottle adapter 914), whereupon threads 978 (not visible in FIG. 9K) of case housing 973 may be assembled to threads 979 of case cap 974, wherein case washer 975 may provide a liquid seal between case cap 974 and case housing 973 such that douche apparatus 900 may be safely stored and remain clean within case 972 until required, despite being carried in a portable fashion, such as in a pants-pocket, bag, purse, backpack and the like. Following use, douche apparatus 900 may be returned to a storage-orientation and may be safely stored until a user may clean douche apparatus 900 and case 972 and store douche apparatus 900 within case 972 such that it is prepared for future use. Due to an attachment of nozzle 902 and adapter assembly 920 of douche apparatus 900 to case cap 974 and an attachment of case cap 974 to case housing 973, a rattling of douche apparatus 900 within case 972 may be prevented. In some implementations, nozzle 902 may be situated wholly in a central portion of adapter assembly 920 as depicted in FIG. 1E, or in some implementations, a portion of nozzle 902 beyond nozzle attachment feature 903 may be situated in a central portion of adapter assembly 920, such as may be the case where in some implementations, nozzle 902 may be longer than adapter assembly 920 and a portion of nozzle 902 may necessarily extend beyond the length of adapter assembly 920.

A number of implementations of a douche apparatus have been disclosed. Various modifications may be made without departing from the spirit and scope of the disclosed douche apparatus and the appended claims. In some implementations, components of douche apparatus disclosed herein may be constructed of a medical grade plastic or some other plastic suitable for intimate bodily contact. In some implementations, such components may be produced using thermoplastic injection molding processes and/or thermoforming processes. In some implementations, other processes may be used such as 3D printing. In some implementations, components of douche apparatus disclosed herein may be constructed of metals, such as stainless steel. In some implementations, such components may be produced using metal forming processes and/or metal machining processes. In some implementations, a combination of metal components and plastic components may employed. In some implementations, O-rings, rubber washers and gaskets may be sourced from commonly available parts, die cut from suitable sheet materials (such as silicone sheet material), injection molded and/or some other suitable method.

The present disclosure is not to be limited in terms of the particular implementations described in this application, which are intended as example implementations of various aspects. Moreover, the various disclosed implementations can be interchangeably used with each other, unless otherwise noted. Many modifications and variations can be made without departing from the spirit and scope of the present disclosure and appended claims, as will be apparent to those skilled in the art. Functionally equivalent methods, components and apparatuses within the scope of the disclosure, in addition to those enumerated herein will be apparent to those skilled in the art from the foregoing descriptions. Such modifications and variations are intended to fall within the scope of the appended claims. It is also to be understood that the terminology used herein is for the purpose of describing particular implementations only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

A number of implementations of the douche apparatus have been described. Various modifications may be made without departing from the spirit and scope of the invention.

What is claimed is:

1. A douche apparatus adaptable to a bottle and configurable for storage and portability, comprising:
a nozzle having a nozzle channel through which a liquid may flow during use, a proximate end having a nozzle attachment feature, a distal end having a nozzle tip and a nozzle body extending from the nozzle attachment feature up to and including the nozzle tip comprising a nozzle wall circumscribing the nozzle channel, wherein the nozzle has at least one orifice disposed on the nozzle tip or the nozzle wall through which a liquid may be dispensed during use; and
an adapter assembly having one or more adapters, a nozzle attachment end mateable to the nozzle attachment feature removably attaching the nozzle to the adapter assembly, a bottle attachment end comprising bottle attachment threads, and an adapter assembly central portion through which a liquid may flow during use, wherein:
the douche apparatus is configurable for storage and portability, wherein the nozzle may be detached from the adapter assembly and the nozzle body may be situated at least partially within the adapter assembly central portion; and
the douche apparatus is adaptable to a squeezable bottle for use, wherein the squeezable bottle comprises a volume of liquid and has bottle threads, wherein the bottle attachment threads are mateable to the bottle threads.

2. The douche apparatus of claim 1, wherein the adapter assembly has a single adapter, and the single adapter comprises the nozzle attachment end and the bottle attachment end.

3. The douche apparatus of claim 1, wherein the bottle attachment end is a second bottle attachment end, and the adapter assembly comprises:
a first adapter comprising the nozzle attachment end and a first bottle attachment end; and
a second adapter comprising the second bottle attachment end and an adapter attachment end mateable and removably attached to the first bottle attachment end, wherein:
the bottle attachment threads are second bottle attachment threads;
the first bottle attachment end comprises first bottle attachment threads mateable with threads of a bottle comprising bottle threads of a first type;
the second bottle attachment end comprises the second bottle attachment threads mateable with threads of a bottle comprising bottle threads of a second type;
the douche apparatus is adaptable to a squeezable bottle for use, wherein the squeezable bottle comprises a volume of liquid and has bottle threads of the second type; and
the douche apparatus is adaptable to a squeezable bottle for use, wherein the squeezable bottle comprises a volume of liquid and has bottle threads of the first type, and the second adapter is detached from the adapter assembly thereby exposing the first bottle attachment end comprising the first bottle attachment threads.

4. The douche apparatus of claim 1, wherein the bottle attachment end is a third bottle attachment end, and the adapter assembly comprises:
a first adapter comprising the nozzle attachment end and a first bottle attachment end;
a second adapter comprising a second bottle attachment end and a first adapter attachment end mateable and removably attached to the first bottle attachment end; and
a third adapter comprising the third bottle attachment end and a second adapter attachment end mateable and removably attached to the second bottle attachment end, wherein:
the bottle attachment threads are third bottle attachment threads;
the first bottle attachment end comprises first bottle attachment threads mateable with threads of a bottle comprising bottle threads of a first type;
the second bottle attachment end comprises second bottle attachment threads mateable with threads of a bottle comprising bottle threads of a second type;
the third bottle attachment end comprises the third bottle attachment threads mateable with threads of a bottle comprising bottle threads of a third type;
the douche apparatus is adaptable to a squeezable bottle for use, wherein the squeezable bottle comprises a volume of liquid and has bottle threads of a third type;
the douche apparatus is adaptable to a squeezable bottle for use, wherein the squeezable bottle comprises a volume of liquid and has bottle threads of a second type, and the third adapter is detached from the adapter assembly thereby exposing the second bottle attachment end comprising the second bottle attachment threads; and
the douche apparatus is adaptable to a squeezable bottle for use, wherein the squeezable bottle comprises a volume of liquid and has bottle threads of the first type, and the second adapter and third adapter are detached from the adapter assembly thereby exposing the first bottle attachment end comprising the first bottle attachment threads.

5. The douche apparatus of claim 1, further comprising a check valve, wherein the check valve is configured be removably attached to the adapter assembly to allow liquid to flow through the adapter assembly and the nozzle channel and dispense through the at least one orifice and to prevent liquid from flowing in a reverse direction thereof.

6. The douche apparatus of claim 1, wherein when configured for storage and portability, the nozzle body may be situated wholly within the adapter assembly central portion.

7. The douche apparatus of claim 1, wherein when configured for storage and portability, the nozzle tip is directed towards the bottle attachment end and the nozzle attachment feature is removably attached to the nozzle attachment end.

8. The douche apparatus of claim 1, further comprising a case having a case housing and a case cap, wherein:
the case cap is removably attachable to the case housing;
the case cap has an exterior side and an interior side, wherein, when attached to the case housing, the interior side is directed towards an interior of the case housing; and
the case cap comprises threads mateable to the bottle attachment end, wherein the adapter assembly is configured to be removably attached to the interior side of the case cap prior to an attachment of the case cap to the case housing, thereby storing the adapter assembly within the case.

9. The douche apparatus of claim 8, wherein the case cap further comprises threads mateable to the nozzle attachment feature, wherein the nozzle is configured to be removably attached to the interior side of the case cap and be situated at least in part within the adapter assembly central portion.

10. The douche apparatus of claim 9, wherein the exterior side of the case cap comprises a recess area proximate to a graspable member of the case cap.

11. The douche apparatus of claim 10, further comprising a check valve, wherein:
the check valve is configured to be removably attached to the adapter assembly at the bottle attachment end, allow liquid to flow through the adapter assembly and the nozzle channel and dispense through the at least one orifice, and prevent liquid from flowing in a reverse direction thereof; and
the case cap is configured to facilitate attachment of the check valve to the adapter assembly, wherein:
a check valve attachment feature of the check valve is configured to be removably attached to threads of the adapter assembly by a rotation of the check valve relative to the adapter assembly; and
the interior side of the case cap is configured to receive an end of the check valve opposite from the check valve attachment feature and prevent a rotation of the check valve relative to the case cap, wherein a grasping and rotating of the graspable member thereby rotates the check valve facilitating attachment of the check valve to the adapter assembly using the case cap as an assembly tool.

12. The douche apparatus of claim 1, further comprising a stimulation device removably attachable to the nozzle attachment end of the adapter assembly.

13. The douche apparatus of claim 12, wherein the stimulation device comprises a vibrator mechanism and a power source for the vibrator mechanism.

14. The douche apparatus of claim 1, wherein each of the one or more adapters comprise a plurality of nubs configured to facilitate a grip thereon.

15. A douche apparatus adaptable to a bottle and configurable for storage and portability, comprising:
a nozzle having a nozzle channel through which a liquid may flow during use, a proximate end having a nozzle attachment feature, a distal end having a nozzle tip and a nozzle body extending from the nozzle attachment feature up to and including the nozzle tip comprising a nozzle wall circumscribing the nozzle channel, wherein the nozzle has at least one orifice disposed on the nozzle tip or the nozzle wall through which a liquid may be dispensed during use;
one or more adapters, each comprising a nozzle attachment end mateable to the nozzle attachment feature removably attaching the nozzle to one of the one or more adapters, a bottle attachment end comprising bottle attachment threads, and an adapter central portion through which a liquid may flow during use; and
a case having a case housing and a case cap, wherein:
the case cap is removably attachable to the case housing;
the case cap has an exterior side and an interior side, wherein, when attached to the case housing, the interior side is directed towards an interior of the case housing;
the case cap comprises threads mateable to the nozzle attachment feature, wherein each of the one or more adapters may be stacked on the case cap having the nozzle body situated at least in part within at least one adapter central portion; and
the douche apparatus is adaptable to a squeezable bottle for use, wherein the squeezable bottle comprises a volume of liquid and has bottle threads, wherein the bottle attachment threads of one of the one or more adapters are mateable to the bottle threads.

16. The douche apparatus of claim 15, wherein the douche apparatus has a single adapter, and the single adapter comprises bottle attachment threads of a first type.

17. The douche apparatus of claim 15, wherein the douche apparatus comprises a first adapter and a second adapter, wherein the first adapter comprises bottle attachment threads of a first type and the second adapter comprises bottle attachment threads of a second type.

18. The douche apparatus of claim 15, wherein the douche apparatus comprises a first adapter, a second adapter and a third adapter, wherein the first adapter comprises bottle attachment threads of a first type, the second adapter comprises bottle attachment threads of a second type and the third adapter comprises bottle attachment threads of a third type.

19. The douche apparatus of claim 17, wherein when configured for storage and portability, the nozzle body may be situated wholly within a combined adapter central portions of the first adapter, second adapter and third adapter.

20. The douche apparatus of claim 15, wherein the exterior side of the case cap comprises a recess area proximate to a graspable member of the case cap.

21. The douche apparatus of claim 15, further comprising a check valve, wherein the check valve is configured to allow liquid to flow through the nozzle channel and dispense through the at least one orifice and prevent liquid from flowing in a reverse direction thereof.
